(19) United States
(12) Patent Application Publication
(10) Pub. No.: US 2014/0278134 A1
(43) Pub. Date: Sep. 18, 2014

(54) Conserved Nucleotide Elements In Ribosomal RNA

(71) Applicant: Brown University, Providence, RI (US)

(72) Inventors: Susan A. Gerbi, Providence, RI (US); Stephen M. Doris, Providence, RI (US); Deborah R. Smith, Providence, RI (US); Julia Beamesderfer, Providence, RI (US); Benjamin J. Raphael, Providence, RI (US)

(73) Assignee: Brown University, Providence, RI (US)

(21) Appl. No.: 14/204,223

(22) Filed: Mar. 11, 2014

Related U.S. Application Data
(60) Provisional application No. 61/798,468, filed on Mar. 15, 2013.

(51) Int. Cl. G06F 19/22

(52) U.S. Cl. CPC G06F 19/22
USPC 702/19

(57) ABSTRACT

The present invention relates to a method of determining conserved ribosomal RNA (rRNA) nucleotide motifs that are specific to one domain of life, Eukarya, Bacteria, or Archaea, and degenerate in at least one other domain of life. The invention also relates to a method of determining conserved ribosomal RNA (rRNA) nucleotide motifs that are specific to one subgroup and degenerate in another subgroup within a domain of life or for a subset group within a domain of life. The invention relates to a method of identifying a compound that is a domain-specific or subgroup-specific ribosomal RNA inhibitor.

### RELATED APPLICATION

This application claims the benefit of U.S. Provisional Application No. 61/798,468, filed on Mar. 15, 2013. The entire teachings of the above application are incorporated herein by reference.

### GOVERNMENT SUPPORT

This invention was made with government support under MCB-0718714 and MCB-1120971 awarded by the National Science Foundation. The government has certain rights in the invention.

### INCORPORATION BY REFERENCE OF MATERIAL IN ASCII TEXT FILE

This application incorporates by reference the Sequence Listing contained in the following ASCII text file being submitted concurrently herewith:
a) File name: 26702024001SeqList.txt; created Mar. 11, 2014, 35 KB in size.

### BACKGROUND OF THE INVENTION

Studies of ribosomal RNA (rRNA) sequence evolution have elucidated deep phylogenetic relationships. However, this powerful approach has not been fully applied to understanding functions of the ribosome itself. Accordingly, a need exists for methods to provide additional insights into aspects of ribosomes. Methods to provide additional insights into aspects of ribosomes can identify drug targets to combat, for example, pathogenic bacteria.

### SUMMARY OF THE INVENTION

The present invention relates to a method of determining conserved ribosomal RNA (rRNA) nucleotide motifs that are specific to one domain of life, Eukarya, Bacteria, or Archaea, and degenerate in at least one other domain of life. The invention also relates to a method of determining conserved ribosomal RNA (rRNA) nucleotide motifs that are specific to one subgroup and degenerate in another subgroup within a domain of life or for a subset group within a domain of life. The invention relates to a method of identifying a compound that is a domain-specific or subgroup-specific ribosomal RNA inhibitor.

In an embodiment, the invention is a method of determining conserved ribosomal RNA (rRNA) nucleotide motifs that are specific to one domain of life and degenerate in at least one other domain of life, comprising the steps of: a) generating a data set of a single copy of full length rRNA sequences, including a greater than or equal to about 70% identity to a sequence of about 15 nucleotides proximate to the 3′ end of the small subunit ribosomal RNA or the large ribosomal subunit RNA, for each of the Eukarya, Bacteria or Archaea domains of life or a merger of the domains of life or for a subgroup within a domain of life; b) filtering the data set against at least one representative structural sequence from each of the Eukarya, Bacteria or Archaea domains of life to align all sequences to the representative secondary structure; c) using overlapping windows of at least about 6 nucleotides for each of the Eukarya, Bacteria or Archaea domains of life to obtain rRNA nucleotide sequences that have an informational content score of greater than or equal to about 11 and a nucleotide sequence identity of greater than about 90%, with subsequent merger of the about 6 nucleotide stretches that overlap to generate a collection of rRNA nucleotide motifs in Eukarya (eCNE=conserved nucleotide elements in Eukarya), rRNA nucleotide motifs in Bacteria (bCNE=conserved nucleotide elements in Bacteria), rRNA nucleotide motifs in Archaea (aCNE=conserved nucleotide elements in Archaea), or in any subgroup within a domain of life; and determining conserved rRNA nucleotide motifs of at least about 6 nucleotides in length that are specific for one domain of life and degenerate in at least one other domain of life from the collection of rRNA nucleotide motifs in Eukarya (domain-specific d-s eCNE), rRNA nucleotide motifs in Bacteria (domain-specific d-s bCNE), and rRNA nucleotide motifs in Archaea (domain-specific d-s aCNE).

In another embodiment, the invention is a method of determining conserved ribosomal RNA (rRNA) nucleotide motifs that are specific to one subgroup and degenerate in at least one other subgroup within Eukarya, comprising the steps of: a) generating a data set of a single copy of full length rRNA sequences, including a greater than or equal to about 70% identity to a sequence of about 15 nucleotides near the 3′ end of the small subunit ribosomal RNA or the large ribosomal subunit RNA, for the Eukarya domain of life or for a subset group with a domain of life; b) filtering the data set against at least one representative structural sequence from the subgroup within Eukarya to align all sequences to the representative secondary structure; c) using overlapping windows of at least about 6 nucleotides for each of the subgroups within Eukarya to obtain rRNA nucleotide sequences that have an informational content score of greater than or equal to about 11 and a nucleotide sequence identity of greater than about 90%, with subsequent merger of the about 6 nucleotide stretches that overlap to generate a collection of rRNA nucleotide motifs in the subgroup within Eukarya; and d) determining conserved rRNA nucleotide motifs of at least about 6 nucleotides in length that are specific for one subgroup within Eukarya and degenerate in at least one other subgroup within Eukarya from the collection of rRNA nucleotide motifs in the subgroup within Eukarya.

In yet another embodiment, the invention is a method of determining conserved ribosomal RNA (rRNA) nucleotide motifs that are specific to one subgroup and degenerate in at least one other subgroup within Bacteria, comprising the steps of: a) generating a data set of a single copy of full length rRNA sequences, including a greater than or equal to about 70% identity to a sequence of about 15 nucleotides near the 3′ end of the small subunit ribosomal RNA or the large ribosomal subunit RNA, for the Bacteria domain of life or for a subset group within a domain of life; b) filtering the data set against at least one representative structural sequence from the subgroup within Bacteria to align all sequences to the representative secondary structure; c) using overlapping windows of at least about 6 nucleotides for each of the subgroups within Bacteria to obtain rRNA nucleotide sequences that have an informational content score of greater than or equal to about 11 and a nucleotide sequence identity of greater than about 90%, with subsequent merger of the about 6 nucleotide stretches that overlap to generate a collection of rRNA nucleotide motifs in the subgroup within Bacteria; and d) determining conserved rRNA nucleotide motifs of at least about 6 nucleotides in length that are specific for one subgroup within Bacteria and degenerate in at least one other subgroup within Bacteria from the collection of rRNA nucleotide motifs in the subgroup within Bacteria.

In a further embodiment, the invention is a method of determining conserved ribosomal RNA (rRNA) nucleotide motifs that are specific to one subgroup and degenerate in at least one other subgroup within Archaea, comprising the steps of: a) generating a data set of a single copy of full length rRNA sequences, including a greater than or equal to about 70% identity to a sequence of about 15 nucleotides near the 3′ end of the small subunit ribosomal RNA or the large ribosomal subunit RNA, for the Archaea domain of life or for a subset group within a domain of life; b) filtering the data set against at least one representative structural sequence from the subgroup within Archaea to align all sequences to the representative secondary structure; c) using overlapping windows of at least about 6 nucleotides for each of the subgroups within Archaea to obtain rRNA nucleotide sequences that have an informational content score of greater than or equal to about 11 and a nucleotide sequence identity of greater than about 90%, with subsequent merger of the about 6 nucleotide stretches that overlap to generate a collection of rRNA nucleotide motifs in the subgroup within Archaea; and d) determining conserved rRNA nucleotide motifs of at least about 6 nucleotides in length that are specific for one subgroup within Archaea and degenerate in at least one other subgroup within Archaea from the collection of rRNA nucleotide motifs in the subgroup within Archaea.

In yet another embodiment, the invention is a method of identifying a compound that is a domain-specific rRNA inhibitor, comprising the steps of: a) generating a space-filling model of an rRNA nucleotide motif identified using the method of claim 1 and a test compound; and b) determining docking of the test compound to at least one rRNA nucleotide motif identified using the method of claim 1 in the space-filling model, wherein the fitting accuracy based on three-dimensional structure and functional surface of the docking of the test compound to the rRNA nucleotide motif identified using the method of claim 1 identifies a compound that specifically inhibits the domain-specific rRNA nucleotide motif identified using the method of claim 1.

In yet another embodiment, the invention is a method of identifying a compound that is a subgroup-specific rRNA inhibitor, comprising the steps of: a) generating a space-filling model of an rRNA nucleotide motif identified using the method of claim 14, 23, or 27 and a test compound; and b) determining docking of the test compound to at least one rRNA nucleotide motif identified using the method of claim 1 in the space-filling model, wherein the fitting accuracy based on three-dimensional structure and functional surface of the docking of the test compound to the rRNA nucleotide motif identified using the method of claim 14, 23, or 27 identifies a compound that specifically inhibits the subgroup-specific rRNA nucleotide motif identified using the method of claim 14, 23, or 27.

### BRIEF DESCRIPTION OF THE DRAWINGS

The patent or application file contains at least one drawing executed in color. Copies of this patent or patent application publication with color drawings will be provided by the Office upon request and payment of the necessary fee.

FIG. 1 CNEs in the large ribosomal subunit of Eukarya. The position of universally conserved uCNEs (≧90% sequence conservation in all three domains) are outlined in red. The domain-specific d-s CNEs that are ≦50% conserved in sequence in the other two domains of life are shown in blue.

FIG. 2. Universal CNEs (uCNEs) in rRNA of the large ribosomal subunit. uCNEs that are conserved in position in the three domains of life are shown in blue. The subset of these that are ≧90% conserved in sequence in all forms of life are outlined in red. Functional regions of the rRNA are labeled (see text).

FIG. 3 Heat map of conservation of CNEs in Eukarya, Archaea and Bacteria. Degree of sequence conservation is color-coded for each CNE, ranging from green (most conserved) through black to red (least conserved).

FIG. 4 Three dimensional view of the large ribosomal subunit. Panel A: crown view (from the subunit interface) of the uCNEs that are ≧90% conserved in sequence in all domains of life. Panel B: crown view for the d-s CNEs in Eukarya with ≦50% sequence conservation in Bacteria and Archaea. In both panels, the L1 stalk is at the upper left of the image.

FIG. 5. Evolutionary distribution of eukaryotic (yellow), archaeal (blue) and bacterial (red) ribosomal RNA sequences within the FLORA databases. Tree of life cladogram within the ARB/SILVA LSU Ref guide tree using the interactive tree of life (iTOL) software platform (http://itol.embl.de/) to show the phylogenetic relationships and branch distances of organisms whose 23S-28S rRNA sequences were included in FLORA and used in this analysis.

FIG. 6 CNEs in the large ribosomal subunit of Archaea. The position of universally conserved uCNEs (≧90% sequence conservation in all three domains) are outlined in red. The domain-specific d-s CNEs that are ≦50% conserved in sequence in the other two domains of life are shown in blue.

FIG. 7 CNEs in the large ribosomal subunit of Bacteria. The position of universally conserved uCNEs (≧90% sequence conservation in all three domains) are outlined in red. The domain-specific d-s CNEs that are ≦50% conserved in sequence in the other two domains of life are shown in blue

### DETAILED DESCRIPTION

In an embodiment, the invention is a method of determining conserved ribosomal RNA (rRNA) nucleotide motifs that are specific to one domain of life and degenerate in at least one other domain of life, comprising the steps of: a) generating a data set of a single copy of full length rRNA sequences, including a greater than or equal to about 70% identity to a sequence of about 15 nucleotides proximate to the 3′ end of the small subunit ribosomal RNA or the large ribosomal subunit RNA, for each of the Eukarya, Bacteria or Archaea domains of life or a merger of the domains of life or for a subgroup within a domain of life; b) filtering the data set against at least one representative structural sequence from each of the Eukarya, Bacteria or Archaea domains of life to align all sequences to the representative secondary structure; c) using overlapping windows of at least about 6 nucleotides for each of the Eukarya, Bacteria or Archaea domains of life to obtain rRNA nucleotide sequences that have an informational content score of greater than or equal to about 11 and a nucleotide sequence identity of greater than about 90%, with subsequent merger of the about 6 nucleotide stretches that overlap to generate a collection of rRNA nucleotide motifs in Eukarya (eCNE=conserved nucleotide elements in Eukarya), rRNA nucleotide motifs in Bacteria (bCNE=conserved nucleotide elements in Bacteria), rRNA nucleotide motifs in Archaea (aCNE=conserved nucleotide elements in Archaea), or in any subgroup within a domain of life; and d) determining conserved rRNA nucleotide motifs of at least about 6 nucleotides in length that are specific for one domain of life and degenerate in at least one other domain of life from the collection of rRNA nucleotide motifs in Eukarya (domain-specific d-s eCNE), rRNA nucleotide motifs in Bacteria (domain-specific d-s bCNE), and rRNA nucleotide motifs in Archaea (domain-specific d-s aCNE).

The representative structural sequence specific for Bacteria can be at least one member selected from the group consisting of Escherichia coli and Clostridium ramosum. The representative structural sequence specific for Eukarya is at least one member selected from the group consisting of Saccharomyces cerevisiae and Arabidopsis thaliana. The representative structural sequence specific for Archaea is at least one member selected from the group consisting of Haloarcula marismortui and Sulfolobus solfataricus.

The conserved rRNA nucleotide motifs can be small ribosomal subunit conserved rRNA nucleotide motifs. The conserved rRNA nucleotide motifs can be large ribosomal subunit conserved rRNA nucleotide motifs. The conserved rRNA nucleotide motifs that are specific to Eukarya (d-s eCNE), Bacteria (d-s bCNE), or Archaea (d-s aCNE) and degenerate to at least one other domain of life can have a length of at least one member selected from the group consisting of at least about 6 nucleotides, at least about 8 nucleotides, at least about 10 nucleotides, at least about 15 nucleotides, at least about 20 nucleotides, at least about 25 nucleotides, at least about 30 nucleotides and at least about 35 nucleotides.

The conserved rRNA nucleotide motif can be specific to Bacteria and degenerate in Eukarya. The conserved rRNA nucleotide motif that is specific to Bacteria can be at least one of AGCACU (SEQ ID NO: 136) or UCGCUCAACG (SEQ ID NO: 163). The Eukarya can be a vertebrate Eukarya. The vertebrate Eukarya can be a human. The Bacteria can be a gram-positive bacteria. The method Bacteria can be gram-negative bacteria.

In another embodiment, the invention is a method of determining conserved ribosomal RNA (rRNA) nucleotide motifs that are specific to one subgroup and degenerate in at least one other subgroup within Eukarya, comprising the steps of: a) generating a data set of a single copy of full length rRNA sequences, including a greater than or equal to about 70% identity to a sequence of about 15 nucleotides near the 3′ end of the small subunit ribosomal RNA or the large ribosomal subunit RNA, for the Eukarya domain of life or for a subset group with a domain of life; b) filtering the data set against at least one representative structural sequence from the subgroup within Eukarya to align all sequences to the representative secondary structure; c) using overlapping windows of at least about 6 nucleotides for each of the subgroups within Eukarya to obtain rRNA nucleotide sequences that have an informational content score of greater than or equal to about 11 and a nucleotide sequence identity of greater than about 90%, with subsequent merger of the about 6 nucleotide stretches that overlap to generate a collection of rRNA nucleotide motifs in the subgroup within Eukarya; and d) determining conserved rRNA nucleotide motifs of at least about 6 nucleotides in length that are specific for one subgroup within Eukarya and degenerate in at least one other subgroup within Eukarya from the collection of rRNA nucleotide motifs in the subgroup within Eukarya.

The conserved rRNA nucleotide motifs can be a small ribosomal subunit conserved rRNA nucleotide motif. The conserved rRNA nucleotide motifs can be a large ribosomal subunit conserved rRNA nucleotide motif. The conserved rRNA nucleotide motif can be specific to Protista and degenerate in other Animalia. The conserved rRNA nucleotide motif can be specific to Fungi and degenerate in other Animalia. The conserved rRNA nucleotide motif can be specific to Nematodes and degenerate in other Animalia. The Animalia can be in the Vertebrata subphylum. The Vertebrata can be a human. The conserved rRNA nucleotide motif can be specific to a sub-group of Eukarya selected from the group consisting of yeast, protozoa, and worms and is degenerate in other subgroups of Eukarya.

In yet another embodiment, the invention is a method of determining conserved ribosomal RNA (rRNA) nucleotide motifs that are specific to one subgroup and degenerate in at least one other subgroup within Bacteria, comprising the steps of: a) generating a data set of a single copy of full length rRNA sequences, including a greater than or equal to about 70% identity to a sequence of about 15 nucleotides near the 3′ end of the small subunit ribosomal RNA or the large ribosomal subunit RNA, for the Bacteria domain of life or for a subset group within a domain of life; b) filtering the data set against at least one representative structural sequence from the subgroup within Bacteria to align all sequences to the representative secondary structure; c) using overlapping windows of at least about 6 nucleotides for each of the subgroups within Bacteria to obtain rRNA nucleotide sequences that have an informational content score of greater than or equal to about 11 and a nucleotide sequence identity of greater than about 90%, with subsequent merger of the about 6 nucleotide stretches that overlap to generate a collection of rRNA nucleotide motifs in the subgroup within Bacteria; and d) determining conserved rRNA nucleotide motifs of at least about 6 nucleotides in length that are specific for one subgroup within Bacteria and degenerate in at least one other subgroup within Bacteria from the collection of rRNA nucleotide motifs in the subgroup within Bacteria. The conserved rRNA nucleotide motifs can be a small ribosomal subunit conserved rRNA nucleotide motif. The conserved rRNA nucleotide motifs can be a large ribosomal subunit conserved rRNA nucleotide motif. The conserved rRNA nucleotide motif can be specific to pathogenic Bacteria and degenerate in other Bacteria.

In yet another embodiment, the invention is a method of determining conserved ribosomal RNA (rRNA) nucleotide motifs that are specific to one subgroup and degenerate in at least one other subgroup within Archaea, comprising the steps of: a) generating a data set of a single copy of full length rRNA sequences, including a greater than or equal to about 70% identity to a sequence of about 15 nucleotides near the 3′ end of the small subunit ribosomal RNA or the large ribosomal subunit RNA, for the Archaea domain of life or for a subset group within a domain of life; b) filtering the data set against at least one representative structural sequence from the subgroup within Archaea to align all sequences to the representative secondary structure; c) using overlapping windows of at least about 6 nucleotides for each of the subgroups within Archaea to obtain rRNA nucleotide sequences that have an informational content score of greater than or equal to about 11 and a nucleotide sequence identity of greater than about 90%, with subsequent merger of the about 6 nucleotide stretches that overlap to generate a collection of rRNA nucleotide motifs in the subgroup within Archaea; and d) determining conserved rRNA nucleotide motifs of at least about 6 nucleotides in length that are specific for one subgroup within Archaea and degenerate in at least one other subgroup within Archaea from the collection of rRNA nucleotide motifs in the subgroup within Archaea.

The conserved rRNA nucleotide motifs can be a small ribosomal subunit conserved rRNA nucleotide motif. The conserved rRNA nucleotide motifs can be a large ribosomal subunit conserved rRNA nucleotide motif. The conserved rRNA nucleotide motif is specific to pathogenic Archaea and degenerate in other Archaea.

In a further embodiment, the invention is a method of identifying a compound that is a domain-specific rRNA inhibitor, comprising the steps of: a) generating a space-filling model of an rRNA nucleotide motif identified using the method of claim 1 and a test compound; and b) determining docking of the test compound to at least one rRNA nucleotide motif identified using the method of claim 1 in the space-filling model, wherein the fitting accuracy based on three-dimensional structure and functional surface of the docking of the test compound to the rRNA nucleotide motif identified using the method of claim 1 identifies a compound that specifically inhibits the domain-specific rRNA nucleotide motif identified using the method of claim 1. In this method, the domain-specific rRNA nucleotide motif can be in the rRNA of Bacteria and not in Eukarya; the domain-specific motif is AGCACU (SEQ ID NO: 136) or UCGCUCAACG (SEQ ID NO: 163) in the rRNA of Bacteria and not in Eukarya. In this method, the domain-specific rRNA nucleotide motif is in rRNA of Archaea and not in Eukarya; the domain-specific rRNA nucleotide motif can be in the small ribosomal subunit; the domain-specific rRNA nucleotide motif is in the large ribosomal subunit.

In yet another embodiment, the invention is a method of identifying a compound that is a subgroup-specific rRNA inhibitor, comprising the steps of: a) generating a space-filling model of an rRNA nucleotide motif identified using the method of claim 14, 23, or 27 and a test compound; and b) determining docking of the test compound to at least one rRNA nucleotide motif identified using the method of claim 1 in the space-filling model, wherein the fitting accuracy based on three-dimensional structure and functional surface of the docking of the test compound to the rRNA nucleotide motif identified using the method of claim 14, 23, or 27 identifies a compound that specifically inhibits the subgroup-specific rRNA nucleotide motif identified using the method of claim 14, 23, or 27. In this method, the subgroup-specific rRNA nucleotide motif can be in rRNA of Eukarya; the subgroup-specific rRNA nucleotide motif can be in rRNA of Bacteria; the subgroup-specific rRNA nucleotide motif is in rRNA of Archaea; the domain-specific rRNA nucleotide motif is in the small ribosomal subunit; the domain-specific rRNA nucleotide motif is in the large ribosomal subunit.

All cells require a system for storing and extracting biological information, and the basic aspects of this system are conserved in all forms of life. Ribosomes are large macromolecular machines that function toward this requirement as the conserved site of protein synthesis. Structural studies of the ribosome have shown that the active site of peptide bond formation is composed solely of ribosomal RNA (rRNA)(1); thus, the ribosome is the largest known ribozyme. This underscores the central role of rRNA in translation and the probability that the initial ribosome in early evolution was composed only of rRNA (2, 3). Since translation is an ancient and ubiquitous process to which rRNA is central, the evolution of rRNA sequences has provided a wealth of information about phylogenetic relationships, including a revised tree of life containing three primary domains: Bacteria, Archaea, and Eukarya (4).

Phylogenetic comparisons have been less mined to understand the function of ribosomes. With regard to ribosome structure, such studies revealed that although the rRNA primary sequence largely differs, a universal core secondary structure is maintained by compensatory base changes (5, 6). Domain-specific features are superimposed on the conserved secondary structure of rRNA, such as the insertion of expansion segments (7) that accounts for the increased length of rRNA in Eukarya compared to Bacteria and Archaea. In addition, a comparative structural analysis of bacterial and archaeal rRNAs revealed domain-specific structural features found within their core structures, including insertions/deletions and alternative secondary or tertiary conformations (8). The presence of these domain-specific features suggests that, outside of the catalytic core, rRNA may have adapted specialized structures, and thus functions, in each lineage. However, this idea is largely unexplored. Ribosomal proteins can be domain-specific, with several occurring in Eukarya (8-11), the universally conserved characteristics of the ribosome is much deeper than the knowledge of the domain-specific characteristics.

As a step towards fully characterizing the specialized structures/functions of the ribosome in each domain of life, we have examined the comparative molecular evolution of 23S-28S ribosomal RNA sequences in a new database that we created to widely represent the phylogenetic diversity within all three domains. Described herein are de novo identification and quantitative characterization of Conserved Nucleotide Elements (CNEs) in rRNA discovered within large ribosomal subunit within each of the three phylogenetic domains of life. Unlike a previous study that identified individual nucleotides that are conserved in Bacteria and Archaea (8), Eukarya is included to identify rRNA sequence conservation in all three domains of life. Moreover, In order to identify potential RNA- and protein-recognition motifs, searched specifically for conserved regions at least six nucleotides in length. Several CNEs were identitied—57, 49 and 47 CNEs that are ≧6 nt in 23S-28S rRNA of Eukarya, Bacteria and Archaea, respectively. Of these, 22 CNEs are universally conserved (uCNEs) in position and sequence in all domains of life, with nine of these ≧90% conserved in sequence. The uCNEs map to regions of rRNA with established functions, but, unexpectedly, some uCNEs reside in areas with no functions identified to date. This underscores the value of our approach to identify new areas in rRNA of potential functional importance. In addition, we also discovered domain-specific (d-s) CNEs that are highly conserved in one domain of life but degenerate in the other domains. The majority of the d-s CNEs are in Eukarya, representing new, not previously appreciated, structural features of eukaryotic ribosomes. Together, these analyses represent a new framework for investigations on the assembly, structure and function of ribosomes.

The major advance of the X-ray crystal structure of the ribosome in Bacteria and Archaea (17-20) and recently in Eukarya (10-11, 21-22) offers snapshots of the dynamic ribosome, which undergoes conformational changes during translation (23), as first visualized by cryo-EM (24). Since the heart of the ribosome is rRNA, understanding its role requires the discovery of which nucleotides are essential for ribosome function. Evolutionary comparisons provide a method to identify sequences within rRNA that are vital for its function. Over evolutionary time, mutations accumulate in nonfunctional nucleotides, whereas sequences important for function are maintained by natural selection. In this study, conserved motifs in the large ribosomal subunit rRNA were identified. The fact that we found the previously known regions of rRNA required for translation validates our approach for identifying novel sequence motifs of potential functional importance. We began by establishing FLORA, with full-length and non-redundant rRNA sequence entries derived from ARB/SILVA, where they are aligned according to secondary structure. Conserved nucleotide elements (CNEs)≧6 nt that are ≧90% conserved in 23S-28S rRNA from each of the three domains of life were identified. Sequence comparisons between the three domains allowed us to discover universal CNEs (uCNEs) and other CNEs that are domain-specific (d-s CNEs).

Universal CNEs (uCNEs)

There are 22 uCNEs that are conserved in their secondary structure position and sequence in 23S-28S rRNA in all three domains of life (Table 1; FIG. 2). Of these, 9 uCNEs are ≧90% conserved in primary sequence in the three domains of life, suggesting that they are essential for the ribosome. When superimposed on the X-ray crystal structure of the yeast 60S ribosomal subunit (10), it can be seen that the uCNE motifs are centrally clustered and mostly at the subunit interface (FIG. 4A). Many of the activities of the ribosome occur at the subunit interface, and several of these coincide with the uCNEs, as discussed below.

Bridges Between the Ribosomal Subunits.

Bridges between the two ribosomal subunits help to coordinate their activities and conformational changes. Of the 12 bridges universal to all domains of life, two-thirds involve the large ribosomal subunit rRNA (10, 20-21). Almost all of the 23S-28S rRNA-containing universal bridges coincide with CNEs (Table 9), most of which are clustered in the secondary structure of 23S-28S rRNA (FIG. 2). In addition, almost all of these bridge-containing CNEs coincide with uCNEs, including two (uCNE 4 and uCNE 5) that are universally ≧90% conserved in sequence (Table 1). Thus, in general, many but not all of the contact sites in 23S-28S rRNA that are involved in universal bridges between the ribosomal subunits coincide with uCNEs (Table 9). Since contact sites have been mapped for only a few of the ribosome states of conformational changes during ratcheting, some of the uCNEs in the bridge region (FIG. 2) may reflect inter-subunit contact sites that are yet to be discovered. In contrast to the universal bridges, the additional eukaryotic-specific bridges (25) involve interactions with expansion segment rRNA or eukaryotic-specific ribosomal proteins and not CNEs.

Peptidyl Transferase Center (PTC).

The peptidyl transferase center (PTC)(26), where peptide bond formation occurs in the large ribosomal subunit, is made up almost exclusively of uCNEs (FIG. 2), including uCNEs 6, 7 and 8 that are ≧90% conserved in sequence in all domains of life. The CCA terminus of tRNA, adjacent to the nascent peptide, also interacts with some nucleotides of the PTC (20, 27), as well as with the P-loop and A-loop (FIG. 2) (28-32). The P-loop and A-loop coincide with CNEs in Eukarya (FIG. 1: eCNEs 45 and 54) and in Bacteria (FIG. 7: bCNEs 32 and 44) but not in Archaea (FIG. 6), and therefore are not classified as uCNEs.

The Sarcin-Ricin Loop (SRL) and GTPase Associated Center (GAC).

The sarcin-ricin loop (SRL) anchors Elongation Factor G (EF-G) on the ribosome during mRNA-tRNA translocation (33). The SRL coincides with uCNE 9 (FIG. 2), which is conserved in ≧90% of rRNA sequences in all three domains of life. The GTPase Associated Center (GAC; FIG. 2) (composed of 23S-28S rRNA helices 43 and 44 and ribosomal protein L11, and is found close to the SRL near the base of the L7/L12 stalk (P stalk in Eukarya)(34)) activates the GTPase activity of translation factors including EF-G. Much of the rRNA sequence composing the GAC is highly conserved in Eukarya (FIG. 1, eCNEs 19-21), moderately in Bacteria (FIG. 7, bCNEs 12-13) and less so in Archaea (FIG. 6, aCNEs 12-13), with the universal overlap of ≧6 nt represented by uCNE 19 (FIG. 2). Just as the uCNEs of the inter-subunit bridges region coincide with areas implicated in conformational changes of the ribosome during translation, the uCNE of the GAC also undergoes conformational changes (34-37).

While many of the uCNEs correspond to region of known function in the ribosome, as discussed above, some are in regions of 23S-28S rRNA of unknown function. Most of these map to the 5′ half of the molecule. Of special interest are uCNEs 1-3 that are ≧90% conserved in sequence in all three domains of life. They underscore the power of our approach to highlight new areas of the ribosome of likely great functional importance that are worthy of future study.

### Domain-Specific CNEs (d-s CNEs)

Of the CNEs found in each domain (eCNEs, aCNEs, bCNEs), only a subset of them are universally conserved in all forms of life (uCNEs), and the remainder shows varying degrees of sequence degeneracy when compared between domains. Those that have ≦50% sequence conservation between domains are termed here domain-specific CNEs (d-s CNEs) and may play important roles unique to ribosomes from that domain of life. To our knowledge, this is the first report of stretches of conserved sequence in rRNA that are domain-specific.

There are two d-s bCNEs (bCNEs 10 and 37; FIG. 7 and Table 8) with sequences that are ≧90% conserved in all Bacteria but ≦50% conserved in the other two domains of life. They represent excellent potential drug targets to combat pathogenic bacteria, as the corresponding rRNA sequences are degenerate in the eukaryotic hosts. Roberts et al. (8) identified individual nt that are conserved signatures of the bacterial or the archaeal domain, with ≧90% conservation in one domain and ≦10% conservation in the other domain. With this rigorous definition, they identified only 4/10 nt in bCNE 37 and none in bCNE 10 as domain-specific signatures in Bacteria. The function of bCNE 37 is unknown. bCNE 10 includes nt U860 and G864 in E. coli that were observed to be strongly deleterious when mutated (38). bCNE10 resides in Helix 38 (H38), named the A-site Finger (ASF) because it interacts with A-site tRNA (20, 39). The apex of H38 forms bridge B1a between the ribosomal subunits, but mutation of the apex cannot account for the lethal phenotype of mutating U860 or G864 (38). The precise function of d-s bCNE 10 as well as d-s bCNE 37 in Bacteria and d-s aCNE 18 in Archaea remain to be established.

In contrast to the one or two d-s CNEs found in Archaea and Bacteria, respectively, there are 12 d-s CNEs in Eukarya (FIGS. 1, 6, 7 and Tables 6-8). Therefore, d-s CNEs are largely a eukaryotic phenomenon. The positions of the d-s eCNEs on the three dimensional structure of the ribosome gives clues to their functions, as discussed below and summarized in Table 10.

The d-s eCNEs form a semi-circle in the large ribosomal subunit.

When superimposed on the X-ray crystal structure of the yeast 60S ribosomal subunit (10), it can be seen that the d-s eCNEs are arranged as a semi-circle cluster, with several exposed to the subunit interface (FIG. 4B). This is reminiscent of the findings of Ben-Shem et al. (10) who found that the expansion segments (not conserved in sequence and structurally distinctive for the eukaryotic domain) are arranged as a ring on the solvent (back) side of the yeast 60S ribosomal subunit. Our data reveal that some of the eCNEs are near expansion segments, including d-s eCNE 34 and d-s eCNE 43 that abut expansion segments ES27L and ES31L, respectively (compare FIG. 1 to FIG. 1 of ref (40)). Perhaps the insertion of these expansion segments created additional evolutionary constraints on the neighboring sequences, resulting in conservation of d-s eCNEs 34 and 43.

In addition to expansion segments, the eukaryotic-specific ribosomal proteins as well as the eukaryotic extensions on the ribosomal proteins found in the other domains of life are associated with this ring (10). Of the six ribosomal proteins that are unique to eukaryotes (10-11, 40), L36e contacts d-s eCNE 37 and L29e contacts d-s eCNEs 14, 16 and 50, as well as eCNEs 10 and 45. Therefore, four of the nine d-s eCNEs contact ribosomal proteins that are unique to eukaryotes.

L1 Stalk.

tRNA leaves the ribosome through the Exit (E) site (41). The dynamic changes in conformation of the rRNA stalk that binds ribosomal protein L1 (27, 42-43) plays a role in the exit of tRNA from the ribosome (42, 44-45). No uCNE is near the L1 stalk (FIG. 2), but eCNEs 42 and 43 are part of this structure (FIG. 1). Moreover, eCNE 43 is a d-s eCNE that is uniquely conserved in Eukarya. This suggests a eukaryotic-specific functional role for d-s eCNE 43 to evacuate tRNA from the ribosome, and complements the notion that the E-site for tRNA on the ribosome evolved relatively late (46-48), as reflected in E site differences between the domains of life (49).

Many eCNEs Coincide with the Tunnel of the Large Ribosomal Subunit.

Nascent polypeptides leave the PTC of the large ribosomal subunit via a tunnel (50-51), the walls of which are primarily composed of rRNA (1, 17, 52-53). The 10-20 Å narrow diameter of the tunnel precludes much folding of the nascent polypeptide beyond the formation of a helices (54). Recently it has been suggested that the tunnel may play a more active, though as yet unknown, role than previously believed (55). In this regard, it is exciting to note that there is enormous overlap of the eCNEs (FIG. 1) with rRNA stretches that compose the tunnel (FIG. 1F of ref (1)). Even more noteworthy is the congruence of d-s eCNEs 14, 16, 23 and 40, accounting for about half of the sequences that are ≧90% conserved in all Eukarya but very degenerate in the other two domains of life. These observations suggest that these d-s eCNEs may play a heretofore unknown function for the tunnel with the nascent polypeptide.

The domain-specific CNEs are prevalent primarily in Eukarya, where they represent a new feature of eukaryotic ribosomes. As discussed above and summarized in Table 10, all of the nine d-s eCNEs, except for d-s eCNE 27, correlate with sites suggesting their potential eukaryotic-specific functions in structure of the ribosome and in translation. Eukaryotic CNEs may also serve as binding sites for biogenesis factors or function in rRNA folding.

Because ribosomal RNA contains a universally conserved core structure, it is believed that the ribosome formed before life differentiated into branches. Upon splitting into three domains, the ribosomes within these branches maintained universal and unique characteristics. At the root of the tree, these features became fixed and remained constant throughout evolution. Tracing of the evolutionary path of 23S-28S rRNA through the study of conserved nucleotide elements (CNEs) is described herein. The invariant nature of CNEs highlights their biological importance, and it appears that CNEs evolved with the basic functions of the cell. Although some of these functions are highlighted here, the analysis of individual CNEs will yield additional insights into previously unknown aspects of ribosomes.

### EXEMPLIFICATION

Studies of ribosomal RNA (rRNA) sequence evolution have elucidated deep phylogenetic relationships. However, this powerful approach has not been fully applied to understanding functions of the ribosome itself. Highly conserved nucleotide elements (CNEs) in 23S-28S rRNA sequences from each phylogenetic domain (Eukarya, Bacteria and Archaea), using a new structurally aligned rRNA database, FLORA (Full-Length Organismal rRNA Alignment) were identified systematically. By quantifying conservation of CNE motifs across phylogenetic domains, we identified universal CNEs (uCNEs) located at the same structural position in all three major branches of the phylogenetic tree and domain-specific CNEs (d-s CNEs) that are uniquely conserved in one phylogenetic domain but absent in the other two. As expected, most uCNEs reside within the functionally important regions of rRNA essential for translation. However, a few uCNEs do not correspond to sites of known function, thus identifying novel sequences in rRNA of potential importance. In contrast to the uCNEs, the d-s CNEs provide new insights into facets of ribosomes that are unique to that domain of life. The d-s CNEs are largely a eukaryotic phenomenon and provide evidence for sites within rRNA that have eukaryotic-specific functions in ribosome biogenesis and translation, including nascent polypeptide transit. Thus, the data described herein give new insight into the evolution of ribosomes and support the hypothesis that motifs within the rRNA core have been tailored by evolution for specialized functions in each phylogenetic domain.

rRNA data were obtained from the SILVA Ref database (12) and curated to create the Full-Length Organismal rRNA Alignment (FLORA) database for 23S-28S rRNA sequences. ARB (56) was used to construct individual position tree servers for each domain of life and for rRNA sequence alignments. A sliding window of 6 nucleotides was used to identify conserved motifs with an information content≧11.0, and overlapping motifs were merged into longer motifs to derive the CNEs. The consensus sequence for the CNE motif in each domain was derived using WebLogo (57), and the percent conservation of each CNE was calculated based on the frequency of mismatches. To identify the uCNEs, the coordinates of the CNEs in each domain of life were aligned in ARB to identify all motifs that were structurally conserved in position. The false discovery rate (FDR) was derived from p-values.

FLORA: The Customization of rDNA Alignments for Optimized, Unbiased Identification of Conserved Elements

The first step in comprehensive rRNA motif discovery is to produce a global sequence alignment with broad phylogenetic representation from each domain of life. Several databases exist for rRNA sequences, but often they just include the small ribosomal subunit rRNA, lack eukaryotic sequences, or are not compatible with high-throughput computational analysis. ARB/SILVA was employed for the study because it provides the most comprehensive resource of rRNA sequences from Bacteria, Archaea and Eukarya, and the thousands of rRNA sequences are aligned according to secondary structure (12-14).

As our starting point, the thousands of sequences in the complete SILVA LSU Reference database of 23S-28S rRNA were catalogued into three position-tree servers according to phylogenetic domain. Several parameters were then used to produce a global alignment containing only complete 23S-28S rRNA sequences: (i) All sequence data containing the term “partial” or “shotgun” in their abstract were eliminated. (ii) Sequences were only included if they had the highly conserved sarcin-ricin loop (SRL) sequence at the 3′ end of 23S-28S rRNA (15). In addition, to avoid phylogenetic biases stemming from the fact that the SILVA LSU Reference database allows multiple entries for a single species, all duplicate species entries were eliminated such that the final datasets contain only one full-length rRNA sequence per species. These steps reduced the number of large ribosomal subunit sequences to 342 (Eukarya), 915 (Bacteria) and 86 (Archaea), which is double the number of entries for each domain of life as used in a previous rRNA database (16; http://www.rna.icmb.utexas.edu). Our refined data set represents a Full-Length Organismal rRNA Alignment (FLORA) that represents a broad distribution of organisms from the tree of life (FIG. 6) and is optimized for comprehensive, global motif discovery.

### Database Construction and Server Construction

Ribosomal RNA data were obtained from the SILVA Comprehensive Ribosomal RNA database maintained by the Microbial Genomics and Bioinformatics Research Group at the Max Planck Institute (58; LSU ref 96) and refined to contain only full length 23S-28S rRNA sequences with only one entry per organism. Accessions that did not contain the 14 nucleotide sarcin-ricin loop (SRL) AGUACGAGAGGAAC sequence at least 70% conserved (i.e., ≦4 mismatches) at the appropriate structural position at the 3′ end of 23S-28S rRNA were eliminated. To balance the distribution of representative organisms from the eukaryotic tree, an equal number of plants were removed from each subtaxon to maintain phylogenetic breadth in the plant species that were retained. As a result of these steps, the Full-Length Organismal rRNA Alignment (FLORA) was created and is publicly available through Brown University and is maintained by the Gerbi Research Group. Organisms in FLORA were organized into phylogenetic trees and individual position tree servers for each domain of life were constructed using ARB (59).

Identification of Conserved Nucleotide Elements (CNEs) in the Large Ribosomal Subunit within Each Domain of Life

Motif discovery in rRNA presents unique challenges owing to the variable lengths of the 23S-28S molecule. This is especially true for the eukaryotes as human 28S rRNA (5100 nt) is about 1.5 times larger than budding yeast 25S rRNA (3400 nt). Much of this variation is due to expansion segments that are of lesser concern because neither their lengths nor sequences are evolutionarily conserved (7). To overcome the problem of rRNA length variation, the analyses began on structurally filtered alignments. A representative model organism was chosen from each domain as the structural filter, producing a database where all alignment columns are structurally homologous to the filtering organism, insertions are excluded, and deletions are held by gaps. This allowed us to compare orthologous positions in rRNA that descended from the same structure throughout evolution. Conserved motifs in each structurally aligned FLORA database using a combined approach of information content (IC) (scores≧11.0) and percent sequence identity 90% throughout the entire domain) was tested. A minimum length of six bases with no maximum length was superimposed in order to select for biologically significant motifs likely to act as either protein- or RNA-binding sites. When carried out separately for each of the three domains of life, this identified 57 eukaryotic conserved nucleotide elements (eCNEs), 49 bacterial CNEs (bCNEs), and 47 archaeal CNES (aCNEs) of various lengths up to 69 bases (Tables 2-4, respectively). In some cases, two adjacent CNEs may be separated by only a few non-conserved nucleotides. To identify any biases imposed by structural filters, CNE motif discovery was repeated using a different filtering organism for each domain of life, chosen from a phylogenetic kingdom that was distant from the first. Both sets of filters discovered the same set of CNEs, with only a few cases where the motif boundaries changed (Tables 2-4). As confirmed by sliding window motif discovery conducted on 500 randomized FLORA alignments, CNEs are exceptionally well conserved above background, with CNEs≧8 nucleotides long showing the lowest false discovery rates (FDRs; Table 5). Thus, the CNEs represent the highly invariant and evolutionarily fixed core of rRNA sequence elements within each domain of life.

By definition, all CNEs are ≧90% conserved within their respective phylogenetic domains, but by conducting cross-domain analysis, how well each motif is conserved in the other two domains was examined (Table 6-8). As evident from conservation heat maps (FIG. 3), CNEs demonstrate varying degrees of sequence degeneracy between phylogenetic domains. Along this continuum, the most degenerate of these sequences (<50% sequence conservation) are identified as domain-specific CNEs (d-s CNEs). There are 9 d-s CNEs in Eukarya, 2 d-s CNEs in Bacteria, and 1 d-s CNE in Archaea (FIGS. 1, 6, 7 and Tables 6-8). Therefore, domain-specific motifs are largely a eukaryotic phenomenon (16% of all CNEs in Eukarya are d-s CNEs compared to 4% in Bacteria and 2% Archaea). Thus, the identification of d-s CNEs focuses attention on special features that may play unique roles for ribosome biogenesis and function in eukaryotes.

### Sequence Alignments

All sequence alignments for the 23S-like molecule were obtained using the alignment tool in ARB (59). For alignment within each domain, a structural filter was employed using Saccharomyces cerevisiae (Sc; Eukarya; Accession J01355), Haloarcula marismortui (Hm; Archaea; Accession X13738), or Escherichia coli (Ec; Bacteria; Accession J01695). This process was repeated using a second structural filter from a different set of organisms: Arabidopsis thaliana (At; Eukarya; Accession X52320), Sulfolobus solfataricus (Ss; Archaea, Accession AE006720) and Clostridium ramosum (Cr; Bacteria; Accession ABFX02000008).

### Motif-Finding Algorithm and Information Content (IC) Scores

Motifs in the rRNA alignments using the following algorithm were identified. First, positions (columns in the alignment) were removed where 10% or more of the sequences contained a non-nucleotide character (e.g., an indel) at the position. For the remaining positions, the position weight matrix (PWM) was computed of length 6 starting at each position. The information content (IC) was computed for each PWM (60) by summing the relative entropy of each column using the following equation:

$${\sum }_{i , j} P ( i , j ) {log}_{2} [ \frac{P ( i , j )}{Q ( i )} ] .$$

Here P(i,j) is the observed frequency of character i at position j in the motif, and Q(i) is the background frequency of character i across all positions of the alignment. In cases, where P(i,j)=0,

$$P ( i , j ) {log}_{2} [ \frac{P ( i , j )}{Q ( i )} ] = 0 ,$$

was set, rather than use pseudocounts. Therefore, each summand (in j) is the relative entropy of the position. Note that if a position is 100% conserved, and the background frequencies are uniform, then the relative entropy of the position equals 2 (bits). Thus, a 100% conserved motif of length L has IC=2L. The position to indicate a conserved motif of length 6 if the IC score of the PWM was at least 11.0 was considered and then merged overlapping motifs into longer motifs to derive the CNEs. Note that the IC scores for the merged CNEs can only be compared between different CNEs if normalized for the various CNE lengths.

### Homology Modeling for 2D and 3D Structures

Homologous sequence positions in the three domains of life were obtained using the ARB (V. 07.12.07) sequence aligner tool matched to S. cerevisiae (Eukarya), H. marismortui (Archaea), or E. coli (Bacteria) for modeling onto the 23S-25S rRNA secondary structures which were downloaded and modified from the Comparative RNA Website (61). The S. cerevisiae X-ray crystal structure was used for three-dimensional modeling (62; PDB 3U5D) using MacPyMol (2006 DeLano Scientific LLC).

### Calculating Percent Conservation of CNEs

The consensus sequence for the CNE motif in each domain (eCNE, aCNE, bCNE) was derived using WebLogo (63). The algorithm to calculate percent conservation for each CNE was performed in two steps, without the use of structural filters. First, the frequency of mismatches relative to the consensus sequence was computed for each position in the alignment and an average mismatch was determined based on total number of aligned sequences. In this calculation, an indel with one or more nucleotides insertion or deletion was penalized as a single nt mismatch. Next, the percent conservation was calculated based on the frequency of mismatches: conservation=(L−M)/L, where L is motif length and M is the average mismatch. The same method just described to calculate the % conservation of a CNE within one domain was used to calculate the % conservation of a given CNE when compared to the consensus motif of its homologous position (based on the ARB secondary structure alignment) in each of the other two domains.

Identification of Universally Conserved Nucleotide Elements (uCNEs)

Homology modeling to position the CNEs from each domain of life onto the secondary structure of rRNA (FIGS. 1, 6, and 7) was used. Although less than half of the CNEs discovered in one domain overlap in structural position with CNEs in the other domains of life, there were 22 universal CNEs (uCNEs) that are structurally conserved in their position in rRNA in all forms of life (FIG. 2). We quantified the sequence conservation of the 22 uCNEs (Table 1); most universal CNEs display at least 80% sequence conservation in all three phylogenetic domains with only 4 exceptions, and 9 of these 22 universal motifs display over 90% sequence conservation across all evolution. The uCNEs are of high statistical significance (Table 5), and, as expected, most of them reside within regions important for translation such as the peptidyl transferase center (uCNE6-8), and regions that undergo conformational changes including the sarcin-ricin loop (uCNE9), GTPase-associated center (uCNE19), and bridges between the ribosomal subunits (uCNE4 and uCNE 5) (FIG. 2). Interestingly, however, some universal CNEs do not correspond to sites of known function, demonstrating the power of our approach to highlight as-yet-uncharacterized features of the ribosome warranting future study.

To identify the universal CNEs, the coordinates of the CNEs in each domain of life were aligned in ARB to identify all motifs that were structurally conserved in position (uCNE). The longest commonly shared core of each structurally conserved CNE was then used to define the 5′ and 3′ uCNE coordinates. To derive the uCNE consensus sequence, a consensus was derived first in each individual domain of life, before deriving the final universal sequence that represents the consensus of the three domains. An “N” is used to indicate positions where a consensus could not be derived. Percent conservation was calculated as described in the preceding section.

### Statistical Tests

To assess the statistical significance of the observed CNEs, p-values were computed by comparing the number of CNEs of a given length to the number of conserved motifs observed in random sequences obtained by permuting the columns of the rRNA alignment. This permutation approach generates a random alignment with the same base composition as the actual rRNA data set, but where the positions of the nucleotide similarities are not preserved. For each such random alignment, the number of conserved sequence motifs with length and information content as least as large in the actual rRNA alignments by computing the IC of position weight matrices in sliding windows across the alignment was computed. 500 permutations were used for all calculations. This permutation test was computed separately in each domain of life to calculate intra-domain p-values. The permutation test was also computed on the merged alignment to compute a p-value for each uCNE. From these p-values, the False Discovery Rate (FDR; 64) for the number of observed CNEs was computed using the method of Siegmund et al. (65).

### REFERENCES

1. Nissen P, Ban N, Hansen J, Moore P B and Steitz T A (2000). The structural basis of ribosome activity in peptide bond synthesis. Science 289: 920-930.
2. Moore P B and Steitz T A (2010) The roles of RNA in the synthesis of protein. Cold Spring Harbor Perspect. Biol. doi: 10.1101/cshperspect.a003780.
3. Noller H F (2012) Evolution of protein synthesis from an RNA world. Cold Spring Harbor Perspect. Biol. 4 (4): a003681. doi: 10.1101.
4. Woese C R, Kandler O and Wheelis M L (1990) Towards a natural system of organisms: proposal for the domains Archaea, Bacteria, and Eucarya. Proc Nat Acad Sci 87: 4576-4579.

5. Clark C G, Tague B W, Ware V C, and Gerbi S A (1984) Xenopus laevis 28S ribosomal RNA: a secondary structure model and its evolutionary and functional implications. Nucleic Acids Res 12: 6197-6220.
6. Gutell R R, Larsen N and Woese C R (1994) Lessons from an evolving rRNA: 16S and 23S rRNA structures from a comparative perspective. Microbiol Rev 58(1):10-26.
7. Gerbi S A (1996) Expansion Segments: Regions of Variable Size that Interrupt the Universal Core Secondary Structure of Ribosomal RNA. “Ribosomal RNA—Structure, Evolution, Processing, and Function in Protein Biosynthesis” (eds.: R. A. Zimmermann and A. E. Dahlberg), 71-87.
8. Roberts E, Sethi A, Montoya J, Woese C R and Luthey-Schulten Z (2008) Molecular signatures of ribosomal evolution. Proc Nat Acad Sci 105: 13953-13958.
9. Dresios, J., Panopoulos, P. and Synetos, D. (2006). Eukaryotic ribosomal proteins lacking a eubacterial counterpart: important players in ribosomal function. Mol Microbiol 59: 1651-1663.
10. Ben-Shem A et al. (2011) The structure of the eukaryotic ribosome at 3.0 Å resolution. Science 334:1524-1529.
11. Klinge S, Voigts-Hoffmann F, Leibundgut M, Arpagaus S and Ban N (2011) Crystal structure of the eukaryotic 60S ribosomal subunit in complex with initiation factor 6. Science 334: 941-948.
12. Pruesse E et al. (2007) SILVA: a comprehensive online resource for quality checked and aligned ribosomal RNA sequence data compatible with ARB. Nucleic Acids Res 35: 7188-7196.
13. Yarza P et al. (2010) Update of the All-Species Living Tree Project based on 16S and 23S rRNA sequence analysis. Syst. Appl. Microbiol. 33, 291-299.
14. Quast C et al. (2013) The SILVA ribosomal RNA gene database project: improved data processing and web-based tools. Nucleic Acids Res. 41 (D1): D590-D596.
15. Chan Y L, Endo Y and Wool I G (1983) The sequence of the nucleotides at the alpha-sarcin cleavage site in rat 28 S ribosomal ribonucleic acid. J Biol Chem 258: 12768-12770.
16. Cannone J J. et al. (2002) The comparative RNA web (CRW) site: an online database of comparative sequence and structure information for ribosomal, intron, and other RNAs. BMC Bioinformatics 3: 2. Erratum: BMC Bioinformatics 3: 15.
17. Ban N, Nissen P, Hansen J, Moore P B and Steitz T A (2000) The complete atomic structure of the large ribosomal subunit at 2.4 Å resolution. Science 289: 905-920.
18. Schluenzen F et al. (2000) Structure of functionally activated small ribosomal subunit at 3.3 angstroms resolution. Cell 102: 615-623.
19. Wimberly B T et al. (2000) Structure of the 30S ribosomal subunit. Nature 407: 327-339.
20. Yusupov M M et al. (2001) Crystal structure of the ribosome at 5.5 A resolution. Science 292: 883-896.
21. Ben-Shem A, Jenner L, Yusupova G and Yusupov M (2010) Crystal structure of the eukaryotic ribosome. Science 330: 1203-1209.
22. Rabl J, Leibundgut M, Ataide S F, Haag A, Ban N (2011) Crystal structure of the eukaryotic 40S ribosomal subunit in complex with initiation factor 1. Science. 331: 730-736.
23. Noeske J and Cate J H D (2012). Structural basis for protein synthesis: snapshots of the ribosome in motion. Curr. Opin. Struct. Biol. 22: 743-749.
24. Frank J and Agrawal R K (2000) A ratchet-like inter-subunit reorganization of the ribosome during translocation. Nature 406: 318-322.
25. Spahn C M et al. (2001) Structure of the 80S ribosome from Saccharomyces cerevisiae—tRNA-ribosome and subunit-subunit interactions. Cell 107: 373-386.
26. Polacek N and Mankin A S (2005) The ribosomal peptidyl transferase center: structure, function, evolution, inhibition. Crit. Rev. Biochem. Mol. Biol. 40: 285-311.
27. Budkevich T et al. (2011) Structure and dynamics of the mammalian ribosomal pretranslocation complex. Mol. Cell. 44:214-224.
28. Samaha R R, Green R and Noller H F (1995) A base pair between tRNA and 23S rRNA in the peptidyl transferase centre of the ribosome. Nature 377: 309-314. Erratum in Nature 378: 419 (1995).
29. Green R, Switzer C and Noller H F (1998) Ribosome-catalyzed peptide bond formation with an A-site substrate covalently linked to 23S ribosomal RNA. Science 280: 286-289.
30. Kim D F and Green R (1999) Base-pairing between 23S rRNA and tRNA in the ribosomal A site. Mol. Cell 4: 859-864.
31. Blanchard S C and Puglisi J D (2001) Solution structure of the A loop of 23S ribosomal RNA. Proc Nat. Acad. Sci. 98:3720-3725.
32. Hansen J L, Schmeing T M, Moore P B and Steitz T A (2002) Structural insights into peptide bond formation. Proc. Nat. Acad. Sci. 99: 1670-11675.
33. Shi X, Khade P K, Sanbonmatsu K Y and Joseph S (2012) Functional role of the sarcin-ricin loop of the 23S rRNA in the elongation cycle of protein synthesis. J. Mol. Biol. 419: 125-138.
34. Li W, Sengupta J, Rath B K and Frank J (2006) Functional conformations of the L11-ribosomal RNA complex revealed by correlative analysis of cryo-EM and molecular dynamics simulations. RNA 12: 1240-1253.
35. Cundliffe E (1987) On the nature of antibiotic binding sites in ribosomes. Biochimie 69: 863-869.
36. Gao Y G et al. (2009) The structure of the ribosome with elongation factor G trapped in the posttranslocation state. Science 326: 694-699.
37. Li W, Trabuco L G, Schulten K and Frank J (2011) Molecular dynamics of EF-G during translocation. Proteins 79: 1478-1486.
38. Yassin A and Mankin A S (2007) Potential new antibiotic sites in the ribosome revealed by deleterious mutations in RNA of the large ribosomal subunit. J. Biol. Chem. 282: 24329-24342.
39. Gao H et al. (2003) Study of the structural dynamics of the E. coli 70S ribosome using real-space refinement. Cell 113: 789-801.
40. Jenner L et al. (2012) Crystal structure of the 80S yeast ribosome. Curr. Opin. Struct. Biol. 22: 759-767.
41. Rheinberger H J, Sternbach H and Nierhaus K H (1981) Thre tRNA binding sites on Escherichia coli ribosomes. Proc. Nat. Acad. Sci. 78: 5310-5314.
42. Cornish P V et al. (2009) Following movement of the L1 stalk between three functional states in single ribosomes. Proc Nat Acad Sci 106:2571-2576.
43. Munro J B et al. (2010) Spontaneous formation of the unlocked state of the ribosome is a multistep process. Proc Nat Acad Sci. 107:709-714.
44. Korostelev A, Ermolenko D N, and Noller H F (2008) Structural dynamics of the ribosome. Curr. Opin. Chem. Biol. 12: 674-683.
45. Trabuco L G et al. (2010) The role of L1 stalk-tRNA interaction in the ribosome elongation cycle. J Mol Biol. 402:741-760.
46. Schmeing T M, Moore P B and Steitz T A (2003) Structure of deacylated tRNA mimics bound to the E site of the large ribosomal subunit. RNA 9: 1345-1352.
47. Selmer M et al. (2006) Structure of the 70S ribosome complexed with mRNA and tRNA. Science 313, 1935-1942.
48. Bokov K and Steinberg S V (2009) A hierarchical model for evolution of 23S ribosomal RNA. Nature 457: 977-980.
49. Dunkle, J A et al., (2011) Structure of the bacterial ribosome in classical and hybrid states of tRNA binding. Science 332: 981-984.

50. Yonath A. Leonard K R and Wittmann H G (1987) A tunnel in the large ribosomal subunit revealed by three-dimensional image reconstruction. Science 236: 813-816.
51. Gabashvili I S et al. (2001) The polypeptide tunnel system in the ribosome and its gating in erythromycin resistance mutants of L4 and L22. Mol. Cell 8: 181-188.
52. Harms J et al. (2001) High resolution structure of the large ribosomal subunit from a mesophilic eubacterium. Cell 107: 679-688.
53. Jenni S and Ban N (2003) The chemistry of protein synthesis and voyage through the ribosomal tunnel. Curr. Opin. Struct. Biol. 13: 212-219.
54. Voss N R, Gerstein M, Steitz T A and Moore P B (2006) The geometry of the ribosomal polypeptide exit tunnel. J. Mol. Biol. 360: 893-906.
55. Wilson D N and Beckmann R (2011) The ribosomal tunnel as a functional environment for nascent polypeptide folding and translational stalling. Curr. Opin. Struct. Biol. 21: 274-282.
56. Ludwig W et al. (2004) ARB: a software environment for sequence data. Nucleic Acids Res 32: 1363-1371.
57. Crooks G E, Hon G, Chandonia J M, Brenner S E (2004). WebLogo: A sequence logo generator. Genome Res 14:1188-1190.
58. Pruesse E et al. (2007) SILVA: a comprehensive online resource for quality checked and aligned ribosomal RNA sequence data compatible with ARB. Nucleic Acids Res 35: 7188-7196.
59. Ludwig W et al. (2004) ARB: a software environment for sequence data. Nucleic Acids Res 32: 1363-1371.
60. Stormo G D (2000) DNA binding sites: representation and discovery. Bioinformatics 16: 16-23.
61. Cannone J J. et al. (2002) The comparative RNA web (CRW) site: an online database of comparative sequence and structure information for ribosomal, intron, and other RNAs. BMC Bioinformatics 3: 2. Erratum: BMC Bioinformatics 3: 15.
62. Ben-Shem A et al. (2011) The structure of the eukaryotic ribosome at 3.0 Å resolution. Science 334:1524-1529.
63. Crooks G E, Hon G, Chandonia J M, Brenner S E (2004). WebLogo: A sequence logo generator. Genome Res 14:1188-1190.
64. Benjamini Y and Hochberg Y (1995) Controlling the false discovery rate. J.R. Stat. Soc. Ser. B 57: 289-300.
65. Siegmund D O, Zhang N R and Yakir B (2011) False discovery rates for scanning statistics. Biometrika 98: 979-985.

TABLE 1
Conservation of universally distributed conserved nucleotide
elements (CNEs).

| uCNE | | | 5′- | % | 5′- | % | 5′- | % |
|---|---|---|---|---|---|---|---|---|
| No. | Motif | Length | Euk | Euk | Arc | Arc | Bac | Bac |
| 1 | CCGAUAG (SEQ ID NO: 1) | 7 | 338 | 97.7 | 450 | 98.8 | 444 | 97.8 |
| 2 | CCUAAG (SEQ ID NO: 2) | 6 | 1530 | 98.4 | 1453 | 96.5 | 1350 | 98.4 |
| 3 | CGUACC (SEQ ID NO: 3) | 6 | 1830 | 90.1 | 1672 | 99.0 | 1600 | 94.9 |
| 4 | UAACUU (SEQ ID NO: 4) | 6 | 1918 | 94.3 | 1763 | 92.2 | 1688 | 98.3 |
| 5 | GACUGUUUA (SEQ ID NO: 5) | 9 | 2129 | 94.7 | 1825 | 93.4 | 1772 | 97.4 |
| 6 | AAGACCC (SEQ ID NO: 6) | 7 | 2400 | 99.7 | 2097 | 98.3 | 2059 | 99.8 |
| 7 | GGAUAAC (SEQ ID NO: 7) | 7 | 2811 | 99.7 | 2477 | 97.2 | 2446 | 100.0 |
| 8 | GAGCUGGGUUUA (SEQ ID | 12 | 2941 | 99.7 | 2606 | 98.0 | 2576 | 93.9 |
| | NO: 8) | | | | | | | |
| 9 | UAGUACGAGAGGAAC (SEQ ID | 15 | 3017 | 98.5 | 2685 | 97.8 | 2653 | 92.8 |
| | NO: 9) | | | | | | | |
| 10 | CUGGUUCCC (SEQ ID NO: 10) | 9 | 937 | 95.0 | 898 | 91.1 | 806 | 86.3 |
| 11 | CAAACUC (SEQ ID NO: 11) | 7 | 1044 | 85.3 | 1003 | 96.8 | 908 | 95.5 |
| 12 | NGUAACUAU (SEQ ID NO: 12) | 9 | 2251 | 88.4 | 1947 | 83.5 | 1909 | 88.0 |
| 13 | ACNCUCUUAAGGUAGC (SEQ ID | 16 | 2261 | 93.1 | 1957 | 95.0 | 1919 | 81.0 |
| | NO: 13) | | | | | | | |
| 14 | GCAUGAA (SEQ ID NO: 14) | 7 | 2306 | 99.7 | 2002 | 98.8 | 1964 | 86.6 |
| 15 | ACUGUCCC (SEQ ID NO: 15) | 8 | 2331 | 99.5 | 2027 | 98.1 | 1989 | 81.7 |
| 16 | AGCUUUACU (SEQ ID NO: 16) | 9 | 2412 | 88.8 | 2109 | 93.8 | 2071 | 91.7 |
| 17 | UUGNUACCUCGAUGUCG (SEQ ID | 17 | 2857 | 82.1 | 2523 | 90.7 | 2492 | 88.1 |
| | NO: 17) | | | | | | | |
| 18 | GACCGUCGUGAGACAGGU (SEQ | 18 | 2953 | 99.7 | 2618 | 97.6 | 2588 | 88.1 |
| | ID NO: 18) | | | | | | | |
| 19 | CGUAACAG (SEQ ID NO: 19) | 8 | 1266 | 74.6 | 1195 | 95.2 | 1092 | 89.8 |
| 20 | UNCCUUGUC (SEQ ID NO: 20) | 9 | 2281 | 77.5 | 1977 | 93.2 | 1939 | 88.3 |
| 21 | GCAUCUA (SEQ ID NO: 21) | 7 | 3112 | 78.9 | 2781 | 99.8 | 2751 | 94.7 |
| 22 | CAUCCUG (SEQ ID NO: 22) | 7 | 2882 | 56.6 | 2548 | 94.4 | 2517 | 95.0 |

TABLE 2
Conserved nucleotide elements (CNEs) in Eukarya.

| | | | Structural filter | | | |
|---|---|---|---|---|---|---|
| eCNE | Eukarya conserved nucleotide elements | | S. cerevisiae | | A. thaliana | |
| No. | eCNE motif | Position | Length | IC Score | Length | IC Score |
| 1 | GCUAAAUA (SEQ ID NO: 23) | 319 | 8 | 15.0 | 8 | 15.1 |
| 2 | CCGAUAGC (SEQ ID NO: 24) | 338 | 8 | 15.2 | 8 | 15.3 |
| 3 | AACAAGUAC (SEQ ID NO: 25) | 347 | 9 | 17.1 | 9 | 17.2 |
| 4 | CCCGUCUUGAAACACGGACCAAG | 635 | 23 | 44.3 | 23 | 44.5 |
| | (SEQ ID NO: 26) | | | | | |
| 5 | ACCCGAA (SEQ ID NO: 27) | 800 | 7 | 12.8 | 7 | 12.9 |
| 6 | AACUAUGC (SEQ ID NO: 28) | 815 | 8 | 14.5 | 8 | 14.6 |
| 7 | GAAACUCUG (SEQ ID NO: 29) | 844 | 9 | 16.9 | 9 | 17.0 |
| 8 | CUGACGUGCAAAUCG (SEQ ID NO: 30) | 872 | 15 | 29.0 | 15 | 29.2 |
| 9 | GGGCGAAAGACUAAUCGAACCAUCUA | 907 | 39 | 72.2 | 39 | 74.2 |
| | GUAGCUGGUUCCC (SEQ ID NO: 31) | | | | | |
| 10 | AAGUUUCCCUCAGGAUAGC (SEQ ID | 950 | 19 | 36.1 | 19 | 36.3 |
| | NO: 32) | | | | | |
| 11 | GGUAAAGC (SEQ ID NO: 33) | 992 | 8 | 14.9 | 8 | 14.9 |
| 12 | AAUGAUUAG (SEQ ID NO: 34) | 1001 | 9 | 15.1 | 9 | 16.8 |
| 13 | CCUAUUCUCAAACUUUAA (SEQ ID NO: | 1036 | 18 | 34.5 | 18 | 34.7 |
| | 35) | | | | | |
| 14 | GUGGGCCA (SEQ ID NO: 36) | 1112 | 8 | 15.0 | 8 | 15.0 |
| 15 | UGGUAAGCA (SEQ ID NO: 37) | 1124 | 9 | 16.7 | 9 | 16.7 |
| 16 | ACUGGCG (SEQ ID NO: 38) | 1135 | 7 | 12.8 | 7 | 12.8 |
| 17 | UGAACC (SEQ ID NO: 39) | 1150 | 6 | 11.2 | 6 | 11.2 |
| 18 | GACAGCA (SEQ ID NO: 40) | 1221 | 7 | 12.8 | 7 | 12.8 |
| 19 | GACGGUGG (SEQ ID NO: 41) | 1229 | 8 | 14.5 | 8 | 14.5 |
| 20 | CAUGGAAGUCG (SEQ ID NO: 42) | 1238 | 11 | 20.5 | 11 | 20.5 |
| 21 | AUCCGCUAAGGAGUGUGUAACAACUC | 1251 | 37 | 71.8 | 37 | 71.7 |
| | ACCUGCCGAAU (SEQ ID NO: 43) | | | | | |
| 22 | CUAGCCCUGAAAAUGGAUGGCGCU | 1291 | 24 | 42.7 | 24 | 44.4 |
| | (SEQ ID NO: 44) | | | | | |
| 23 | GCAGAUCUUGGU (SEQ ID NO: 45) | 1430 | 12 | 22.3 | 12 | 22.4 |
| 24 | GGUAGUAGCAAAUAUUCA (SEQ ID | 1442 | 18 | 33.2 | 18 | 33.2 |
| | NO: 46) | | | | | |
| 25 | GGUUCCAU (SEQ ID NO: 47) | 1491 | 8 | 14.5 | 8 | 14.5 |
| 26 | UCCUAAG (SEQ ID NO: 48) | 1529 | 7 | 13.3 | 7 | 13.3 |
| 27 | UCUUUUCU (SEQ ID NO: 49) | 1682 | 8 | 15.6 | 8 | 15.5 |
| 28 | CCUUGAAAA (SEQ ID NO: 50) | 1790 | 9 | 16.8 | 9 | 16.8 |
| 29 | UCGUACU (SEQ ID NO: 51) | 1829 | 7 | 12.5 | 7 | 12.5 |
| 30 | AACCGCAUCAGGUCUCCAAGGU (SEQ | 1839 | 22 | 41.5 | 22 | 41.5 |
| | ID NO: 52) | | | | | |
| 31 | CAGCCUCUG (SEQ ID NO: 53) | 1864 | 9 | 16.3 | 9 | 16.4 |
| 32 | AGGGAAGUCGGCAA (SEQ ID NO: 54) | 1894 | 14 | 26.2 | 14 | 26.2 |
| 33 | GAUCCGUAACUUCG (SEQ ID NO: 55) | 1912 | 14 | 26.4 | 14 | 26.4 |
| 34 | AGGAUUGGCUCU (SEQ ID NO: 56) | 1931 | 12 | 22.6 | 12 | 22.6 |
| 35 | AUCCGACUGUUUAAUUAAAACA (SEQ | 2125 | 22 | 42.0 | 22 | 42.0 |
| | ID NO: 57) | | | | | |
| 36 | GUGAUUUCUGCCCAGUGCUCUGAAUG | 2184 | 30 | 58.5 | 30 | 58.4 |
| | UCAA (SEQ ID NO: 58) | | | | | |
| 37 | AAUUCAA (SEQ ID NO: 59) | 2222 | 7 | 13.1 | 7 | 13.0 |
| 38 | CAAGCGCGGGUAAACGGCGGGAGUAA | 2230 | 69 | 133.2 | 69 | 133.1 |
| | CUAUGACUCUCUUAAGGUAGCCAAAU | | | | | |
| | GCCUCGUCAUCUAAUUA (SEQ ID NO: | | | | | |
| | 60) | | | | | |
| 39 | UGACGCGCAUGAAUGGAUUAACGAG | 2300 | 41 | 79.0 | 41 | 78.9 |
| | AUUCCCACUGUCCCUA (SEQ ID NO: 61) | | | | | |
| 40 | UCUACUAUCUAGCGAAACCACAGCCA | 2341 | 35 | 63.0 | 35 | 64.4 |
| | AGGGAACGG (SEQ ID NO: 62) | | | | | |
| 41 | AGCGGGGAAAGAAGACCCUGUUGAGC | 2389 | 37 | 71.9 | 37 | 71.9 |
| | UUGACUCUAGU (SEQ ID NO: 63) | | | | | |
| 42 | AAAUACCACUAC (SEQ ID NO: 64) | 2483 | 12 | 22.1 | 12 | 22.1 |
| 43 | UUUACUUAUU (SEQ ID NO: 65) | 2507 | 10 | 18.5 | 10 | 18.4 |
| 44 | GAGUUUG (SEQ ID NO: 66) | 2607 | 7 | 13.0 | 7 | 12.9 |
| 45 | CUGGGGC (SEQ ID NO: 67) | 2615 | 7 | 13.2 | 7 | 13.2 |
| 46 | ACAUCUGU (SEQ ID NO: 68) | 2625 | 8 | 15.2 | 8 | 15.2 |
| 47 | GUGUCCUAAG (SEQ ID NO: 69) | 2648 | 10 | 18.3 | 10 | 18.3 |
| 48 | ACAGAAAUCU (SEQ ID NO: 70) | 2673 | 10 | 18.4 | 9 | 16.6 |
| 49 | UUGAUU (SEQ ID NO: 71) | 2709 | 6 | 11.2 | 6 | 11.2 |
| 50 | AUUUUCAGU (SEQ ID NO: 72) | 2717 | 8 | 14.7 | 6 | 11.0 |
| 51 | UGGCCUAUCGAUCCUUUA (SEQ ID NO: | 2748 | 18 | 33.6 | 18 | 33.6 |
| | 73) | | | | | |
| 52 | CAGAAAAGUUACCACAGGGAUAACUG | 2794 | 35 | 68.4 | 35 | 68.3 |
| | GCUUGUGGC (SEQ ID NO: 74) | | | | | |
| 53 | GCCAAGCGUUCAUAGCGACGUUGCUU | 2830 | 59 | 115.5 | 59 | 115.4 |
| | UUUGAUCCUUCGAUGUCGGCUCUUCC | | | | | |
| | UAUCAUU (SEQ ID NO: 75) | | | | | |
| 54 | GGAUUGUUCACCCAC (SEQ ID NO: 76) | 2913 | 15 | 29.3 | 15 | 29.3 |
| 55 | AGGGAACGUGAGCUGGGUUUAGACC | 2932 | 56 | 109.5 | 56 | 109.4 |
| | GUCGUGAGACAGGUUAGUUUUACCCU | | | | | |
| | ACUGA (SEQ ID NO: 77) | | | | | |
| 56 | UAGUACGAGAGGAAC (SEQ ID NO: 78) | 3017 | 15 | 28.3 | 15 | 28.2 |
| 57 | CGCCUCUA (SEQ ID NO: 79) | 3111 | 8 | 14.7 | 8 | 14.7 |

TABLE 3
Conserved nucleotide elements (CNEs) in Archaea.

| | | | Structural filter | | | |
|---|---|---|---|---|---|---|
| aCNE | Archaea conserved nucleotide elements | | H. marismortui | | S. solfataricus | |
| No. | aCNE motif | Position | Length | IC Score | Length | IC Score |
| 1 | AAACAUCUUA (SEQ ID NO: 80) | 165 | 10 | 18.1 | 10 | 18.1 |
| 2 | UAAAUA (SEQ ID NO: 81) | 434 | 6 | 11.1 | 6 | 11.1 |
| 3 | ACCGAUAG (SEQ ID NO: 82) | 449 | 8 | 15.2 | 8 | 15.2 |
| 4 | CUGAAAAG (SEQ ID NO: 83) | 480 | 8 | 15.4 | 8 | 15.4 |
| 5 | UGAAAC (SEQ ID NO: 84) | 517 | 6 | 11.4 | 6 | 11.4 |
| 6 | CGAUCUA (SEQ ID NO: 85) | 773 | 7 | 13.4 | 7 | 13.4 |
| 7 | CCAAUC (SEQ ID NO: 86) | 878 | 6 | 11.2 | 6 | 11.2 |
| 8 | CUGGUUCCC (SEQ ID NO: 87) | 898 | 9 | 16.1 | 9 | 16.1 |
| 9 | UCAAACUCCGAA (SEQ ID NO: 88) | 1002 | 12 | 22.8 | 12 | 22.8 |
| 10 | GGUUAAGG (SEQ ID NO: 89) | 1092 | 8 | 14.3 | 8 | 14.3 |
| 11 | CUAAGUG (SEQ ID NO: 90) | 1114 | 7 | 13.0 | 7 | 13.0 |
| 12 | AGCAGC (SEQ ID NO: 91) | 1173 | 6 | 11.4 | 6 | 11.4 |
| 13 | CGUAACAG (SEQ ID NO: 92) | 1195 | 8 | 14.5 | 8 | 14.5 |
| 14 | UGGACC (SEQ ID NO: 93) | 1336 | 6 | 11.2 | 6 | 11.2 |
| 15 | AUCCUG (SEQ ID NO: 94) | 1356 | 6 | 11.0 | N/D | N/D |
| 16 | GGUCCUAAG (SEQ ID NO: 95) | 1450 | 9 | 16.1 | 9 | 16.1 |
| 17 | GGUUAAUAUUCC (SEQ ID NO: 96) | 1495 | 12 | 24.5 | 12 | 24.5 |
| 18 | CGUAAU (SEQ ID NO: 97) | 1592 | 6 | 11.1 | 6 | 11.1 |
| 19 | UGAAAA (SEQ ID NO: 98) | 1651 | 6 | 11.1 | 6 | 11.1 |
| 20 | CCGUACC (SEQ ID NO: 99) | 1671 | 7 | 13.1 | 7 | 13.1 |
| 21 | AGGGAA (SEQ ID NO: 100) | 1739 | 6 | 11.0 | 6 | 11.0 |
| 22 | UCGGCAAAUU (SEQ ID NO: 101) | 1746 | 10 | 18.9 | 10 | 18.9 |
| 23 | UAACUU (SEQ ID NO: 102) | 1763 | 6 | 11.2 | 6 | 11.2 |
| 24 | GUCGCA (SEQ ID NO: 103) | 1803 | 6 | 11.1 | 6 | 11.1 |
| 25 | GACUGUUUAAU (SEQ ID NO: 104) | 1825 | 11 | 20.1 | 11 | 20.1 |
| 26 | AACAUA (SEQ ID NO: 105) | 1839 | 6 | 11.1 | 6 | 11.1 |
| 27 | GGUAACUAU (SEQ ID NO: 106) | 1947 | 9 | 16.8 | 9 | 16.8 |
| 28 | ACCCUCUUAAGGUAGC (SEQ ID NO: 107) | 1957 | 16 | 31.6 | 16 | 31.6 |
| 29 | UACCUUGCC (SEQ ID NO: 108) | 1977 | 9 | 16.2 | 9 | 16.1 |
| 30 | GCAUGAAU (SEQ ID NO: 109) | 2002 | 8 | 15.2 | 8 | 15.2 |
| 31 | CACUGUCCC (SEQ ID NO: 110) | 2026 | 9 | 17.2 | 9 | 17.2 |
| 32 | AAGACCC (SEQ ID NO: 111) | 2097 | 7 | 13.4 | 7 | 13.4 |
| 33 | GAGCUUUACUGCA (SEQ ID NO: 112) | 2108 | 13 | 24.4 | 13 | 24.4 |
| 34 | GCAGUU (SEQ ID NO: 113) | 2269 | 6 | 11.2 | 6 | 11.2 |
| 35 | AGAAAA (SEQ ID NO: 114) | 2461 | 6 | 11.1 | 6 | 11.1 |
| 36 | CUACCCC (SEQ ID NO: 115) | 2468 | 7 | 12.4 | 7 | 12.4 |
| 37 | GGAUAAC (SEQ ID NO: 116) | 2477 | 7 | 12.8 | 7 | 12.8 |
| 38 | UUGCUACCUC (SEQ ID NO: 117) | 2523 | 10 | 18.6 | 10 | 18.6 |
| 39 | GAUGUCG (SEQ ID NO: 118) | 2533 | 7 | 13.0 | 7 | 13.0 |
| 40 | CCAUCCUGG (SEQ ID NO: 119) | 2547 | 9 | 15.2 | 9 | 16.8 |
| 41 | AAGGGU (SEQ ID NO: 120) | 2571 | 6 | 11.3 | 6 | 11.3 |
| 42 | CCUAUUAAAGG (SEQ ID NO: 121) | 2588 | 11 | 20.3 | 11 | 20.3 |
| 43 | UGAGCUGGGUUUAGACCGUCG | 2605 | 31 | 58.3 | 31 | 58.3 |
| | UGAGACAGGU (SEQ ID NO: 122) | | | | | |
| 44 | UAGUACGAGAGGAAC (SEQ ID NO: 123) | 2685 | 15 | 28.0 | 15 | 28.0 |
| 45 | GUUGUC (SEQ ID NO: 124) | 2726 | 6 | 11.2 | 6 | 11.1 |
| 46 | GCUGAA (SEQ ID NO: 125) | 2774 | 6 | 11.4 | 6 | 11.4 |
| 47 | GCAUCUAAGC (SEQ ID NO: 126) | 2781 | 10 | 19.7 | 10 | 19.7 |

TABLE 4
Conserved nucleotide elements (CNEs) in Bacteria.

| | | | Structural filter | | | |
|---|---|---|---|---|---|---|
| bCNE | Bacteria conserved nucleotide elements | | E. coli | | C. ramosum | |
| No. | bCNE motif | Position | Length | IC Score | Length | IC Score |
| 1 | UGAAACAUCU (SEQ ID NO: 127) | 193 | 10 | 19.3 | 10 | 19.3 |
| 2 | CUAAAU (SEQ ID NO: 128) | 426 | 6 | 11.1 | 6 | 11.1 |
| 3 | ACCGAUAG (SEQ ID NO: 129) | 443 | 8 | 15.0 | 8 | 15.0 |
| 4 | AGUACCGU (SEQ ID NO: 130) | 457 | 8 | 15.1 | 8 | 15.1 |
| 5 | CCUUUUG (SEQ ID NO: 131) | 564 | 7 | 13.4 | 7 | 13.4 |
| 6 | ACCCGAA (SEQ ID NO: 132) | 670 | 7 | 13.2 | 7 | 13.2 |
| 7 | UGAUCUA (SEQ ID NO: 133) | 683 | 7 | 13.2 | 7 | 13.2 |
| 8 | CCGAAC (SEQ ID NO: 134) | 731 | 6 | 11.3 | 6 | 11.3 |
| 9 | AAUAGCUGGUUCUCC (SEQ ID NO: | 802 | 14 | 26.0 | 14 | 26.0 |
| | 135) | | | | | |
| 10 | AGCACU (SEQ ID NO: 136) | 863 | 6 | 11.5 | 6 | 11.5 |
| 11 | CAAACUC (SEQ ID NO: 137) | 908 | 7 | 12.8 | 7 | 12.8 |
| 12 | GAAGCAGCCA (SEQ ID NO: 138) | 1068 | 10 | 18.4 | 10 | 18.4 |
| 13 | GCGUAAUAGCUCACUG (SEQ ID | 1091 | 16 | 29.9 | 16 | 29.9 |
| | NO: 139) | | | | | |
| 14 | UGAGUA (SEQ ID NO: 140) | 1263 | 6 | 11.1 | 6 | 11.1 |
| 15 | CCUAAG (SEQ ID NO: 141) | 1350 | 6 | 11.5 | 6 | 11.5 |
| 16 | CGUACC (SEQ ID NO: 142) | 1600 | 6 | 11.2 | 6 | 11.2 |
| 17 | ACCGACAC (SEQ ID NO: 143) | 1610 | 8 | 15.2 | 8 | 15.2 |
| 18 | AGGAACUCGGC (SEQ ID NO: 144) | 1665 | 11 | 20.2 | 11 | 20.2 |
| 19 | CCGUAACUUCGG (SEQ ID NO: 145) | 1685 | 12 | 22.6 | 12 | 22.6 |
| 20 | GACUGUUUA (SEQ ID NO: 146) | 1772 | 9 | 17.8 | 9 | 17.8 |
| 21 | AAAAACACAG (SEQ ID NO: 147) | 1783 | 10 | 18.6 | 10 | 18.6 |
| 22 | ACGCCUGCCCGGU (SEQ ID NO: 148) | 1829 | 13 | 24.1 | 13 | 24.1 |
| 23 | AAGCCC (SEQ ID NO: 149) | 1889 | 6 | 11.2 | 6 | 11.2 |
| 24 | AACGGC (SEQ ID NO: 150) | 1900 | 6 | 11.3 | 6 | 11.2 |
| 25 | CCGUAACUAUAACGGUCCUAAGG | 1908 | 42 | 81.1 | 42 | 81.1 |
| | UAGCGAAAUUCCUUGUCGG (SEQ | | | | | |
| | ID NO: 151) | | | | | |
| 26 | GUAAGUUCCGACCUGCACGAA | 1950 | 21 | 39.1 | 21 | 39.1 |
| | (SEQ ID NO: 152) | | | | | |
| 27 | ACUGUCUC (SEQ ID NO: 153) | 1989 | 8 | 15.9 | 8 | 15.9 |
| 28 | AAAGACCCCGU (SEQ ID NO: 154) | 2058 | 11 | 20.1 | 11 | 20.1 |
| 29 | ACCUUUACU (SEQ ID NO: 155) | 2071 | 9 | 17.5 | 9 | 17.5 |
| 30 | UCUAAC (SEQ ID NO: 156) | 2195 | 6 | 11.3 | 6 | 11.3 |
| 31 | CAGUUUG (SEQ ID NO: 157) | 2240 | 7 | 12.4 | 7 | 12.4 |
| 32 | UGGGGC (SEQ ID NO: 158) | 2249 | 6 | 11.2 | 6 | 11.2 |
| 33 | GCCUCCCAA (SEQ ID NO: 159) | 2259 | 9 | 16.4 | 9 | 16.4 |
| 34 | GUAACGGA (SEQ ID NO: 160) | 2271 | 8 | 15.1 | 8 | 15.1 |
| 35 | UUGACUG (SEQ ID NO: 161) | 2343 | 7 | 12.9 | 7 | 12.9 |
| 36 | UAGUGAUCCG (SEQ ID NO: 162) | 2387 | 10 | 19.6 | 10 | 19.6 |
| 37 | UCGCUCAACG (SEQ ID NO: 163) | 2419 | 10 | 18.9 | 10 | 18.9 |
| 38 | GAUAAAAG (SEQ ID NO: 164) | 2429 | 8 | 14.8 | 8 | 14.8 |
| 39 | GGGAUAACAGGCUGAU (SEQ ID | 2445 | 16 | 30.1 | 16 | 30.1 |
| | NO: 165) | | | | | |
| 40 | CACAUCGACG (SEQ ID NO: 166) | 2475 | 10 | 18.4 | 10 | 18.4 |
| 41 | GUUUGGCACCUCGAUGUCGGCUC | 2490 | 26 | 51.8 | 26 | 51.8 |
| | AUC (SEQ ID NO: 167) | | | | | |
| 42 | CAUCCUGGG (SEQ ID NO: 168) | 2517 | 9 | 16.1 | 9 | 16.1 |
| 43 | GUCCCAAGGGU (SEQ ID NO: 169) | 2536 | 11 | 20.7 | 11 | 20.7 |
| 44 | GGCUGUUCGCC (SEQ ID NO: 170) | 2549 | 11 | 22.1 | 11 | 22.1 |
| 45 | UUAAAG (SEQ ID NO: 171) | 2562 | 6 | 11.5 | 6 | 11.5 |
| 46 | GAGCUGGGUUCA (SEQ ID NO: 172) | 2576 | 12 | 22.4 | 12 | 22.4 |
| 47 | GAACGUCGUGAGACAGUUCGGUC | 2588 | 30 | 56.7 | 30 | 56.7 |
| | CCUAUCU (SEQ ID NO: 173) | | | | | |
| 48 | CUAGUACGAGAGGACC (SEQ ID | 2652 | 16 | 29.9 | 16 | 29.9 |
| | NO: 174) | | | | | |
| 49 | GCAUCUAA (SEQ ID NO: 175) | 2751 | 8 | 14.7 | 8 | 14.7 |

TABLE 5
Summary of conserved nucleotide element false
discovery rates (FDRs).

| Length | Euk CNE | Arc CNE | Bac CNE | Univ CNE |
|---|---|---|---|---|
| 6 | 0.549517241 | 0.279764706 | 0.38428 | 0.116222222 |
| 7 | 0.288321429 | 0.197225806 | 0.229435897 | 0.053789474 |
| 8 | 0.198208333 | 0.141666667 | 0.156363636 | 0.025882353 |
| 9 | 0.158944444 | 0.097666667 | 0.110615385 | 0.0175 |
| 10 | 0.108258065 | 0.070923077 | 0.072818182 | 0.0086 |
| 11 | 0.066785714 | 0.047555556 | 0.050125 | 0.00475 |
| 12 | 0.040518519 | 0.031428571 | 0.033166667 | 0.0032 |
| 13 | 0.030666667 | 0.03 | 0.0248 | 0.002 |
| 14 | 0.020833333 | 0.023 | 0.017555556 | 0.000666667 |
| 15 | 0.015454545 | 0.0185 | 0.01225 | 0 |
| 16 | 0.013578947 | 0.02 | 0.008 | 0 |
| 17 | 0.011052632 | 0.022 | 0.0104 | 0 |
| 18 | 0.008210526 | 0.017 | 0.008 | 0 |
| 19 | 0.00775 | 0.01 | 0.0068 | 0 |
| 20 | 0.006933333 | 0.01 | 0.0064 | 0 |
| 21 | 0.006 | 0.007 | 0.0048 | 0 |
| 22 | 0.005333333 | 0.006 | 0.006 | 0 |
| 23 | 0.005846154 | 0.004 | 0.004 | 0 |
| 24 | 0.006727273 | 0.003 | 0.004 | 0 |
| 25 | 0.006363636 | 0.003 | 0.004 | 0 |
| 26 | 0.006 | 0.003 | 0.004 | 0 |
| 27 | 0.005818182 | 0.002 | 0.004 | 0 |
| 28 | 0.005454545 | 0.002 | 0.004 | 0 |
| 29 | 0.005454545 | 0.002 | 0.002 | 0 |
| 30 | 0.004727273 | 0.002 | 0.001333333 | 0 |

TABLE 6
Cross-domain conservation of CNEs from eukaryotes.
The domain-specific (DS) CNEs are indicated.

| eCNE | Euk | Euk | Arc | Arc | Bac | Bac |
|---|---|---|---|---|---|---|
| No. | Position | Percent | Position | Percent | Position | Percent |
| 1 | 319 | 98.0 | 432 | 87.6 | 425 | 92.7 |
| 2 | 338 | 97.8 | 450 | 94.3 | 444 | 89.6 |
| 3 | 347 | 98.1 | 459 | 73.5 | 453 | 83.5 |
| 4 | 635 | 98.3 | 619 | 73.3 | 562 | 47.4 |
| 5 | 800 | 96.9 | 760 | 82.8 | 670 | 98.0 |
| 6 | 815 | 96.5 | 775 | 69.3 | 685 | 66.5 |
| 7 | 844 | 97.7 | 804 | 57.3 | 714 | 32.5 |
| 8 | 872 | 98.8 | 832 | 66.0 | 741 | 39.0 |
| 9 | 907 | 97.2 | 868 | 68.2 | 776 | 68.7 |
| 10 | 950 | 97.7 | 911 | 56.1 | 819 | 46.6 |
| 11 | 992 | 98.7 | 951 | 79.2 | 858 | 89.5 |
| 12 | 1001 | 97.7 | 960 | 64.5 | 866 | 62.1 |
| 13 | 1036 | 97.3 | 995 | 56.1 | 900 | 46.3 |
| 14^{DS} | 1112 | 99.0 | 1040 | 33.2 | 942 | 46.4 |
| 15 | 1124 | 98.2 | 1052 | 67.4 | 954 | 47.1 |
| 16^{DS} | 1135 | 98.2 | 1063 | 38.9 | 966 | 40.7 |
| 17 | 1150 | 96.9 | 1078 | 67.3 | 981 | 57.4 |
| 18 | 1221 | 97.2 | 1150 | 86.6 | 1047 | 73.9 |
| 19 | 1229 | 99.0 | 1158 | 64.5 | 1055 | 54.6 |
| 20 | 1238 | 98.7 | 1167 | 58.9 | 1064 | 63.4 |
| 21 | 1251 | 98.7 | 1180 | 74.8 | 1077 | 64.5 |
| 22 | 1291 | 96.6 | 1220 | 65.6 | 1117 | 60.5 |
| 23^{DS} | 1430 | 97.8 | 1352 | 45.5 | 1250 | 48.7 |
| 24 | 1442 | 97.9 | 1364 | 53.0 | 1262 | 45.5 |
| 25 | 1491 | 96.0 | 1414 | 72.1 | 1310 | 69.3 |
| 26 | 1529 | 97.9 | 1452 | 89.1 | 1349 | 85.6 |
| 27^{DS} | 1682 | 96.4 | 1558 | 4.9 | 1456 | 23.6 |
| 28 | 1790 | 97.7 | 1649 | 76.2 | 1565 | 64.7 |
| 29 | 1829 | 91.6 | 1671 | 74.4 | 1599 | 70.4 |
| 30 | 1839 | 96.8 | 1681 | 58.1 | 1609 | 57.5 |
| 31 | 1864 | 93.5 | 1707 | 53.4 | 1634 | 42.6 |
| 32 | 1894 | 99.1 | 1739 | 92.1 | 1664 | 83.3 |
| 33 | 1912 | 96.8 | 1757 | 80.6 | 1682 | 81.6 |
| 34^{DS} | 1931 | 98.2 | 1776 | 33.8 | 1701 | 45.2 |
| 35 | 2125 | 96.9 | 1821 | 80.5 | 1768 | 76.5 |
| 36 | 2184 | 98.6 | 1879 | 64.9 | 1826 | 70.6 |
| 37^{DS} | 2222 | 97.3 | 1917 | 11.8 | 1871 | −1191.7 |
| 38 | 2230 | 98.8 | 1926 | 72.3 | 1888 | 74.1 |
| 39 | 2300 | 98.2 | 1996 | 77.8 | 1958 | 66.2 |
| 40^{DS} | 2341 | 96.7 | 2037 | 43.9 | 1999 | 34.3 |
| 41 | 2389 | 99.5 | 2086 | 73.0 | 2048 | 60.5 |
| 42 | 2483 | 96.5 | 2211 | 60.8 | 2169 | 69.9 |
| 43^{DS} | 2507 | 96.4 | 2234 | 46.0 | 2192 | 42.9 |
| 44 | 2607 | 98.7 | 2270 | 87.0 | 2240 | 82.2 |
| 45 | 2615 | 99.2 | 2278 | 96.8 | 2248 | 97.4 |
| 46 | 2625 | 97.8 | 2288 | 51.3 | 2258 | 34.5 |
| 47 | 2648 | 97.0 | 2311 | 71.9 | 2280 | 65.1 |
| 48 | 2673 | 95.6 | 2336 | 62.5 | 2305 | 60.6 |
| 49 | 2709 | 97.1 | 2374 | 61.6 | 2343 | 77.6 |
| 50^{DS} | 2717 | 94.3 | 2383 | −1.2 | 2352 | 27.5 |
| 51 | 2748 | 96.6 | 2415 | 68.0 | 2382 | 54.7 |
| 52 | 2794 | 99.5 | 2460 | 76.5 | 2427 | 66.3 |
| 53 | 2830 | 98.1 | 2496 | 66.7 | 2465 | 68.9 |
| 54 | 2913 | 98.2 | 2578 | 65.1 | 2548 | 64.0 |
| 55 | 2932 | 99.4 | 2597 | 76.1 | 2567 | 68.4 |
| 56 | 3017 | 98.7 | 2685 | 97.8 | 2653 | 92.8 |
| 57 | 3111 | 90.2 | 2780 | 80.7 | 2750 | 70.3 |

^{DS}= domain specific conservation

TABLE 7
Cross-domain conservation of CNEs from Archaea.
The domain-specific (DS) CNEs are indicated.

| aCNE | Arc | Arc | Euk | Euk | Bac | Bac |
|---|---|---|---|---|---|---|
| No. | Position | Perc | Position | Perc | Position | Percent |
| 1 | 165 | 90.0 | 39 | 58.0 | 195 | 88.4 |
| 2 | 434 | 92.6 | 321 | 97.9 | 427 | 94.5 |
| 3 | 449 | 97.4 | 337 | 95.2 | 443 | 97.8 |
| 4 | 480 | 99.1 | 368 | 84.9 | 474 | 82.4 |
| 5 | 517 | 96.1 | 404 | 85.5 | 511 | 96.1 |
| 6 | 773 | 95.0 | 813 | 70.3 | 683 | 84.3 |
| 7 | 878 | 94.2 | 917 | 82.7 | 786 | 90.2 |
| 8 | 898 | 91.1 | 937 | 95.0 | 806 | 86.3 |
| 9 | 1002 | 96.0 | 1043 | 75.0 | 907 | 88.4 |
| 10 | 1092 | 96.4 | 1164 | 88.7 | 996 | 76.1 |
| 11 | 1114 | 95.3 | 1186 | 47.2 | 1018 | 91.3 |
| 12 | 1173 | 99.8 | 1244 | 50.3 | 1070 | 99.3 |
| 13 | 1195 | 95.2 | 1266 | 74.6 | 1092 | 89.8 |
| 14 | 1336 | 97.9 | 1414 | 72.9 | 1234 | 74.0 |
| 15 | 1356 | 93.6 | 1434 | 81.2 | 1254 | 68.8 |
| 16 | 1450 | 94.3 | 1527 | 89.4 | 1346 | 44.7 |
| 17 | 1495 | 98.6 | 1597 | 55.7 | 1388 | 90.1 |
| 18^{DS} | 1592 | 95.3 | 1718 | 27.6 | 1492 | 41.7 |
| 19 | 1651 | 96.1 | 1793 | 98.6 | 1567 | 77.3 |
| 20 | 1671 | 95.2 | 1829 | 79.9 | 1599 | 93.4 |
| 21 | 1739 | 100.0 | 1894 | 99.7 | 1664 | 83.1 |
| 22 | 1746 | 96.4 | 1901 | 90.1 | 1671 | 88.8 |
| 23 | 1763 | 92.2 | 1918 | 94.3 | 1688 | 98.3 |
| 24 | 1803 | 96.7 | 2107 | 45.3 | 1750 | 85.9 |
| 25 | 1825 | 91.9 | 2129 | 95.4 | 1772 | 84.0 |
| 26 | 1839 | 92.2 | 2143 | 87.3 | 1786 | 83.8 |
| 27 | 1947 | 91.3 | 2251 | 88.5 | 1909 | 88.6 |
| 28 | 1957 | 97.6 | 2261 | 93.1 | 1919 | 81.3 |
| 29 | 1977 | 87.5 | 2281 | 66.5 | 1939 | 77.5 |
| 30 | 2002 | 97.4 | 2306 | 99.6 | 1964 | 83.5 |
| 31 | 2026 | 94.8 | 2330 | 98.5 | 1988 | 81.4 |
| 32 | 2097 | 98.3 | 2400 | 99.7 | 2059 | 99.8 |
| 33 | 2108 | 95.7 | 2411 | 76.9 | 2070 | 78.6 |
| 34 | 2269 | 95.7 | 2606 | 82.3 | 2239 | 89.1 |
| 35 | 2461 | 98.3 | 2795 | 99.2 | 2428 | 65.9 |
| 36 | 2468 | 87.0 | 2802 | 70.8 | 2437 | 71.6 |
| 37 | 2477 | 97.2 | 2811 | 99.7 | 2446 | 100.0 |
| 38 | 2523 | 93.0 | 2857 | 69.8 | 2492 | 79.9 |
| 39 | 2533 | 97.7 | 2867 | 99.7 | 2502 | 99.9 |
| 40 | 2547 | 95.1 | 2881 | 62.0 | 2516 | 83.3 |
| 41 | 2571 | 99.8 | 2906 | 81.1 | 2541 | 99.9 |
| 42 | 2588 | 93.0 | 2923 | 58.2 | 2558 | 78.0 |
| 43 | 2605 | 97.8 | 2940 | 99.7 | 2575 | 89.0 |
| 44 | 2685 | 97.8 | 3017 | 98.5 | 2653 | 92.8 |
| 45 | 2726 | 94.6 | 3059 | 59.2 | 2694 | 88.4 |
| 46 | 2774 | 98.4 | 3105 | 80.1 | 2744 | 94.6 |
| 47 | 2781 | 98.8 | 3112 | 74.5 | 2751 | 89.7 |

^{DS}= domain specific conservation

TABLE 8
Cross-domain conservation of CNEs from Bacteria.
The domain-specific (DS) CNEs are indicated.

| bCNE | Bac | Bac | Euk | Euk | Arc | Arc |
|---|---|---|---|---|---|---|
| No. | Position | Percent | Position | Percent | Position | Percent |
| 1 | 193 | 95.2 | 37 | 55.3 | 163 | 91.6 |
| 2 | 426 | 94.9 | 320 | 97.9 | 433 | 91.9 |
| 3 | 443 | 97.8 | 337 | 95.2 | 449 | 97.4 |
| 4 | 457 | 96.9 | 351 | 91.0 | 463 | 91.3 |
| 5 | 564 | 94.3 | 637 | 70.1 | 621 | 69.8 |
| 6 | 670 | 98.0 | 800 | 97.0 | 760 | 87.9 |
| 7 | 683 | 95.8 | 813 | 83.8 | 773 | 88.7 |
| 8 | 731 | 97.8 | 861 | 59.5 | 821 | 53.7 |
| 9 | 802 | 94.6 | 933 | 75.7 | 894 | 78.0 |
| 10^{DS} | 863 | 95.9 | 997 | 49.2 | 956 | 46.1 |
| 11 | 908 | 95.4 | 1044 | 85.3 | 1003 | 96.7 |
| 12 | 1068 | 98.6 | 1242 | 60.6 | 1171 | 91.9 |
| 13 | 1091 | 95.8 | 1265 | 69.6 | 1194 | 76.1 |
| 14 | 1263 | 96.8 | 1443 | 66.8 | 1365 | 69.0 |
| 15 | 1350 | 98.2 | 1530 | 98.4 | 1453 | 96.5 |
| 16 | 1600 | 94.8 | 1830 | 90.1 | 1672 | 99.0 |
| 17 | 1610 | 98.0 | 1840 | 58.9 | 1682 | 93.5 |
| 18 | 1665 | 97.0 | 1895 | 81.5 | 1740 | 84.8 |
| 19 | 1685 | 97.2 | 1915 | 96.0 | 1760 | 91.8 |
| 20 | 1772 | 97.4 | 2129 | 94.7 | 1825 | 93.4 |
| 21 | 1783 | 98.9 | 2140 | 80.0 | 1836 | 87.8 |
| 22 | 1829 | 95.3 | 2187 | 69.1 | 1882 | 75.7 |
| 23 | 1889 | 97.6 | 2231 | 83.3 | 1927 | 73.1 |
| 24 | 1900 | 99.0 | 2242 | 99.2 | 1938 | 89.1 |
| 25 | 1908 | 98.3 | 2250 | 73.7 | 1946 | 77.0 |
| 26 | 1950 | 96.4 | 2292 | 62.5 | 1988 | 77.0 |
| 27 | 1989 | 94.1 | 2331 | 87.0 | 2027 | 85.6 |
| 28 | 2058 | 92.9 | 2399 | 81.4 | 2096 | 85.3 |
| 29 | 2071 | 93.4 | 2412 | 77.7 | 2109 | 82.9 |
| 30 | 2195 | 95.9 | 2510 | 51.8 | 2237 | 74.4 |
| 31 | 2240 | 89.5 | 2607 | 84.6 | 2270 | 90.5 |
| 32 | 2249 | 99.5 | 2616 | 99.2 | 2279 | 99.6 |
| 33 | 2259 | 90.1 | 2627 | 48.0 | 2290 | 55.9 |
| 34 | 2271 | 99.6 | 2639 | 75.6 | 2302 | 53.2 |
| 35 | 2343 | 94.6 | 2709 | 69.3 | 2374 | 75.6 |
| 36 | 2387 | 99.0 | 2753 | 69.4 | 2420 | 67.6 |
| 37^{DS} | 2419 | 97.4 | 2787 | 30.1 | 2453 | 37.0 |
| 38 | 2429 | 99.1 | 2796 | 49.9 | 2462 | 51.5 |
| 39 | 2445 | 98.4 | 2810 | 81.0 | 2476 | 76.2 |
| 40 | 2475 | 93.9 | 2840 | 78.3 | 2506 | 73.7 |
| 41 | 2490 | 98.3 | 2855 | 76.7 | 2521 | 79.4 |
| 42 | 2517 | 95.0 | 2882 | 53.0 | 2548 | 66.4 |
| 43 | 2536 | 97.5 | 2901 | 57.9 | 2566 | 77.0 |
| 44 | 2549 | 99.4 | 2914 | 72.4 | 2579 | 89.1 |
| 45 | 2562 | 98.7 | 2927 | 42.9 | 2592 | 96.5 |
| 46 | 2576 | 96.5 | 2941 | 91.4 | 2606 | 92.0 |
| 47 | 2588 | 95.9 | 2953 | 66.5 | 2618 | 82.9 |
| 48 | 2652 | 97.6 | 3016 | 87.9 | 2684 | 87.1 |
| 49 | 2751 | 94.1 | 3112 | 80.4 | 2781 | 99.7 |

^{DS}= domain specific conservation

TABLE 9
Inter-subunit bridges involving 23S-28S rRNA CNEs.

| Bridge* | uCNE | eCNE |
|---|---|---|
| B1a*** | X | X |
| B2a | uCNE 12, 13 | eCNE 38 |
| B2b | uCNE 13 | eCNE 36, 38 |
| B2c | X | eCNE 36 |
| B3 | uCNE 20 | eCNE 38, 39 |
| B4*** | X | eCNE 7 |
| B5** | uCNE 4, 15 | X |
| B6 | uCNE 4 | X |
| B7a | X | eCNE 36, 38 |

*Positions of bridges taken from Yusupov et al. (2001) for bacteria and Ben-Shem et al. (2010, 2011) for yeast.
**Bridge B5 has shifted upward from its positions in bacteria upward to sites in an expansion segment region in yeast.
***Bridges B1a and B4 are not clustered with the other rRNA-containing bridges

TABLE 10
Correlation of domain-specific eCNEs with ribosome functions.

| d-s eCNE | |
|---|---|
| No. | Function |
| 14 | tunnel; contacts eukaryotic-specific ribosomal protein L29e |
| 16 | tunnel; contacts eukaryotic-specific ribosomal protein L29e |
| 23 | tunnel |
| 27 | unknown |
| 34 | abuts expansion segment 27L |
| 37 | contacts eukaryotic-specific ribosomal protein L36e |
| 40 | tunnel |
| 43 | E site tRNA; abuts expansion segment 31L |
| 50 | contacts eukaryotic-specific ribosomal protein L29e |

The teachings of all of the above references are hereby incorporated by reference in their entirety.

While this invention has been particularly shown and described with references to example embodiments thereof, it will be understood by those skilled in the art that various changes in form and details may be made therein without departing from the scope of the invention encompassed by the appended claims.

What is claimed is:

1. A method of determining conserved ribosomal RNA (rRNA) nucleotide motifs that are specific to one domain of life and degenerate in at least one other domain of life, comprising the steps of:
a) generating a data set of a single copy of full length rRNA sequences, including a greater than or equal to about 70% identity to a sequence of about 15 nucleotides proximate to the 3′ end of the small subunit ribosomal RNA or the large ribosomal subunit RNA, for each of the Eukarya, Bacteria or Archaea domains of life or a merger of the domains of life or for a subgroup within a domain of life;
b) filtering the data set against at least one representative structural sequence from each of the Eukarya, Bacteria or Archaea domains of life to align all sequences to the representative secondary structure;
c) using overlapping windows of at least about 6 nucleotides for each of the Eukarya, Bacteria or Archaea domains of life to obtain rRNA nucleotide sequences that have an informational content score of greater than or equal to about 11 and a nucleotide sequence identity of greater than about 90%, with subsequent merger of the about 6 nucleotide stretches that overlap to generate a collection of rRNA nucleotide motifs in Eukarya (eCNE=conserved nucleotide elements in Eukarya), rRNA nucleotide motifs in Bacteria (bCNE=conserved nucleotide elements in Bacteria), rRNA nucleotide motifs in Archaea (aCNE=conserved nucleotide elements in Archaea), or in any subgroup within a domain of life; and
d) determining conserved rRNA nucleotide motifs of at least about 6 nucleotides in length that are specific for one domain of life and degenerate in at least one other domain of life from the collection of rRNA nucleotide motifs in Eukarya (domain-specific d-s eCNE), rRNA nucleotide motifs in Bacteria (domain-specific d-s bCNE), and rRNA nucleotide motifs in Archaea (domain-specific d-s aCNE).

2. The method of claim 1, wherein the representative structural sequence specific for Bacteria is at least one member selected from the group consisting of Escherichia coli and Clostridium ramosum.

3. The method of claim 1, wherein the representative structural sequence specific for Eukarya is at least one member selected from the group consisting of Saccharomyces cerevisiae and Arabidopsis thaliana.

4. The method of claim 1, wherein the representative structural sequence specific for Archaea is at least one member selected from the group consisting of Haloarcula marismortui and Sulfolobus solfataricus.

5. The method of claim 1, wherein the conserved rRNA nucleotide motifs are small ribosomal subunit conserved rRNA nucleotide motifs.

6. The method of claim 1, wherein the conserved rRNA nucleotide motifs are large ribosomal subunit conserved rRNA nucleotide motifs.

7. The method of claim 1, wherein the conserved rRNA nucleotide motifs that are specific to Eukarya (d-s eCNE), Bacteria (d-s bCNE), or Archaea (d-s aCNE) and degenerate to at least one other domain of life have a length of at least one member selected from the group consisting of at least about 6 nucleotides, at least about 8 nucleotides, at least about 10 nucleotides, at least about 15 nucleotides, at least about 20 nucleotides, at least about 25 nucleotides, at least about 30 nucleotides and at least about 35 nucleotides.

8. The method of claim 1, wherein the conserved rRNA nucleotide motif is specific to Bacteria and degenerate in Eukarya.

9. The method of claim 8, wherein the conserved rRNA nucleotide motif that is specific to Bacteria is at least one of AGCACU or UCGCUCAACG.

10. The method of claim 8, wherein the Eukarya is a vertebrate Eukarya.

11. The method of claim 10, wherein the vertebrate Eukarya is a human

12. The method of claim 8, wherein the Bacteria is gram-positive bacteria.

13. The method of claim 8, wherein the Bacteria is gram-negative bacteria.

14. A method of determining conserved ribosomal RNA (rRNA) nucleotide motifs that are specific to one subgroup and degenerate in at least one other subgroup within Eukarya, comprising the steps of:
a) generating a data set of a single copy of full length rRNA sequences, including a greater than or equal to about 70% identity to a sequence of about 15 nucleotides near the 3′ end of the small subunit ribosomal RNA or the large ribosomal subunit RNA, for the Eukarya domain of life or for a subset group with a domain of life;
b) filtering the data set against at least one representative structural sequence from the subgroup within Eukarya to align all sequences to the representative secondary structure;
c) using overlapping windows of at least about 6 nucleotides for each of the subgroups within Eukarya to obtain rRNA nucleotide sequences that have an informational content score of greater than or equal to about 11 and a nucleotide sequence identity of greater than about 90%, with subsequent merger of the about 6 nucleotide stretches that overlap to generate a collection of rRNA nucleotide motifs in the subgroup within Eukarya; and
d) determining conserved rRNA nucleotide motifs of at least about 6 nucleotides in length that are specific for one subgroup within Eukarya and degenerate in at least one other subgroup within Eukarya from the collection of rRNA nucleotide motifs in the subgroup within Eukarya.

15. The method of claim 14, wherein the conserved rRNA nucleotide motifs are a small ribosomal subunit conserved rRNA nucleotide motif.

16. The method of claim 14, wherein the conserved rRNA nucleotide motifs are a large ribosomal subunit conserved rRNA nucleotide motif.

17. The method of claim 14, wherein the conserved rRNA nucleotide motif is specific to Protista and degenerate in other Animalia.

18. The method of claim 14, wherein the conserved rRNA nucleotide motif is specific to Fungi and degenerate in other Animalia.

19. The method of claim 14, wherein the conserved rRNA nucleotide motif is specific to Nematodes and degenerate in other Animalia.

20. The method of claim 14, wherein the Animalia is in the Vertebrata subphylum.

21. The method of claim 20, wherein the Vertebrata is a human.

22. The method of claim 14, wherein the conserved rRNA nucleotide motif is specific to a sub-group of Eukarya selected from the group consisting of yeast, protozoa, and worms and is degenerate in other subgroups of Eukarya.

23. A method of determining conserved ribosomal RNA (rRNA) nucleotide motifs that are specific to one subgroup and degenerate in at least one other subgroup within Bacteria, comprising the steps of:
a) generating a data set of a single copy of full length rRNA sequences, including a greater than or equal to about 70% identity to a sequence of about 15 nucleotides near the 3′ end of the small subunit ribosomal RNA or the large ribosomal subunit RNA, for the Bacteria domain of life or for a subset group within a domain of life;
b) filtering the data set against at least one representative structural sequence from the subgroup within Bacteria to align all sequences to the representative secondary structure;
c) using overlapping windows of at least about 6 nucleotides for each of the subgroups within Bacteria to obtain rRNA nucleotide sequences that have an informational content score of greater than or equal to about 11 and a nucleotide sequence identity of greater than about 90%, with subsequent merger of the about 6 nucleotide stretches that overlap to generate a collection of rRNA nucleotide motifs in the subgroup within Bacteria; and
d) determining conserved rRNA nucleotide motifs of at least about 6 nucleotides in length that are specific for one subgroup within Bacteria and degenerate in at least one other subgroup within Bacteria from the collection of rRNA nucleotide motifs in the subgroup within Bacteria.

24. The method of claim 23, wherein the conserved rRNA nucleotide motifs are a small ribosomal subunit conserved rRNA nucleotide motif.

25. The method of claim 23, wherein the conserved rRNA nucleotide motifs are a large ribosomal subunit conserved rRNA nucleotide motif.

26. The method of claim 23, wherein the conserved rRNA nucleotide motif is specific to pathogenic Bacteria and degenerate in other Bacteria.

27. A method of determining conserved ribosomal RNA (rRNA) nucleotide motifs that are specific to one subgroup and degenerate in at least one other subgroup within Archaea, comprising the steps of:
a) generating a data set of a single copy of full length rRNA sequences, including a greater than or equal to about 70% identity to a sequence of about 15 nucleotides near the 3′ end of the small subunit ribosomal RNA or the large ribosomal subunit RNA, for the Archaea domain of life or for a subset group within a domain of life;
b) filtering the data set against at least one representative structural sequence from the subgroup within Archaea to align all sequences to the representative secondary structure;
c) using overlapping windows of at least about 6 nucleotides for each of the subgroups within Archaea to obtain rRNA nucleotide sequences that have an informational content score of greater than or equal to about 11 and a nucleotide sequence identity of greater than about 90%, with subsequent merger of the about 6 nucleotide stretches that overlap to generate a collection of rRNA nucleotide motifs in the subgroup within Archaea; and
d) determining conserved rRNA nucleotide motifs of at least about 6 nucleotides in length that are specific for one subgroup within Archaea and degenerate in at least one other subgroup within Archaea from the collection of rRNA nucleotide motifs in the subgroup within Archaea.

28. The method of claim 27, wherein the conserved rRNA nucleotide motifs are a small ribosomal subunit conserved rRNA nucleotide motif.

29. The method of claim 27, wherein the conserved rRNA nucleotide motifs are a large ribosomal subunit conserved rRNA nucleotide motif.

30. The method of claim 27, wherein the conserved rRNA nucleotide motif is specific to pathogenic Archaea and degenerate in other Archaea.

31. A method of identifying a compound that is a domain-specific rRNA inhibitor, comprising the steps of:
a) generating a space-filling model of an rRNA nucleotide motif identified using the method of claim 1 and a test compound; and
b) determining docking of the test compound to at least one rRNA nucleotide motif identified using the method of claim 1 in the space-filling model,
wherein the fitting accuracy based on three-dimensional structure and functional surface of the docking of the test compound to the rRNA nucleotide motif identified using the method of claim 1 identifies a compound that specifically inhibits the domain-specific rRNA nucleotide motif identified using the method of claim 1.

32. The method of claim 31, wherein the domain-specific rRNA nucleotide motif is in the rRNA of Bacteria and not in Eukarya.

33. The method of claim 32, wherein the domain-specific motif is AGCACU (SEQ ID NO: 136) or UCGCUCAACG (SEQ ID NO: 163) in the rRNA of Bacteria and not in Eukarya.

34. The method of claim 31, wherein the domain-specific rRNA nucleotide motif is in rRNA of Archaea and not in Eukarya.

35. The method of claim 31, wherein the domain-specific rRNA nucleotide motif is in the small ribosomal subunit.

36. The method of claim 31, wherein the domain-specific rRNA nucleotide motif is in the large ribosomal subunit.

37. A method of identifying a compound that is a subgroup-specific rRNA inhibitor, comprising the steps of:
a) generating a space-filling model of an rRNA nucleotide motif identified using the method of claim 14 and a test compound; and
b) determining docking of the test compound to at least one conserved rRNA nucleotide motif that is specific to one domain of life and degenerate in at least one other domain of life in the space-filling model,
wherein the fitting accuracy based on three-dimensional structure and functional surface of the docking of the test compound to the rRNA nucleotide motif identified using the method of claim 14 identifies a compound that specifically inhibits the subgroup-specific rRNA nucleotide motif identified using the method of claim 14.

38. The method of claim 37, wherein the subgroup-specific rRNA nucleotide motif is in rRNA of Eukarya.

39. The method of claim 37, wherein the subgroup-specific rRNA nucleotide motif is in rRNA of Bacteria.

40. The method of claim 37, wherein the subgroup-specific rRNA nucleotide motif is in rRNA of Archaea.

41. The method of claim 37, wherein the domain-specific rRNA nucleotide motif is in the small ribosomal subunit.

42. The method of claim 37, wherein the domain-specific rRNA nucleotide motif is in the large ribosomal subunit.


SEQUENCE LISTING (175 sequences)

SEQ ID NO: 1 - RNA, 7 nt, Artificial Sequence
  Universal conserved nucleotide elements
ccgauag

SEQ ID NO: 2 - RNA, 6 nt, Artificial Sequence
  Universal conserved nucleotide elements
ccuaag

SEQ ID NO: 3 - RNA, 6 nt, Artificial Sequence
  Universal conserved nucleotide elements
cguacc

SEQ ID NO: 4 - RNA, 6 nt, Artificial Sequence
  Universal conserved nucleotide elements
uaacuu

SEQ ID NO: 5 - RNA, 9 nt, Artificial Sequence
  Universal conserved nucleotide elements
gacuguuua

SEQ ID NO: 6 - RNA, 7 nt, Artificial Sequence
  Universal conserved nucleotide elements
aagaccc

SEQ ID NO: 7 - RNA, 7 nt, Artificial Sequence
  Universal conserved nucleotide elements
ggauaac

SEQ ID NO: 8 - RNA, 12 nt, Artificial Sequence
  Universal conserved nucleotide elements
gagcuggguuua

SEQ ID NO: 9 - RNA, 15 nt, Artificial Sequence
  Universal conserved nucleotide elements
uaguacgagaggaac

SEQ ID NO: 10 - RNA, 9 nt, Artificial Sequence
  Universal conserved nucleotide elements
cugguuccc

SEQ ID NO: 11 - RNA, 7 nt, Artificial Sequence
  Universal conserved nucleotide elements
caaacuc

SEQ ID NO: 12 - RNA, 9 nt, Artificial Sequence
  Universal conserved nucleotide elements
nguaacuau

SEQ ID NO: 13 - RNA, 16 nt, Artificial Sequence
  Universal conserved nucleotide elements
acncucuuaagguagc

SEQ ID NO: 14 - RNA, 7 nt, Artificial Sequence
  Universal conserved nucleotide elements
gcaugaa

SEQ ID NO: 15 - RNA, 8 nt, Artificial Sequence
  Universal conserved nucleotide elements
acuguccc

SEQ ID NO: 16 - RNA, 9 nt, Artificial Sequence
  Universal conserved nucleotide elements
agcuuuacu

SEQ ID NO: 17 - RNA, 17 nt, Artificial Sequence
  Universal conserved nucleotide elements
uugnuaccucgaugucg

SEQ ID NO: 18 - RNA, 18 nt, Artificial Sequence
  Universal conserved nucleotide elements
gaccgucgugagacaggu

SEQ ID NO: 19 - RNA, 8 nt, Artificial Sequence
  Universal conserved nucleotide elements
cguaacag

SEQ ID NO: 20 - RNA, 9 nt, Artificial Sequence
  Universal conserved nucleotide elements
unccuuguc

SEQ ID NO: 21 - RNA, 7 nt, Artificial Sequence
  Universal conserved nucleotide elements
gcaucua

SEQ ID NO: 22 - RNA, 7 nt, Artificial Sequence
  Universal conserved nucleotide elements
cauccug

SEQ ID NO: 23 - RNA, 8 nt, Artificial Sequence
  Eukarya conserved nucleotide elements
gcuaaaua

SEQ ID NO: 24 - RNA, 8 nt, Artificial Sequence
  Eukarya conserved nucleotide elements
ccgauagc

SEQ ID NO: 25 - RNA, 9 nt, Artificial Sequence
  Eukarya conserved nucleotide elements
aacaaguac

SEQ ID NO: 26 - RNA, 23 nt, Artificial Sequence
  Eukarya conserved nucleotide elements
cccgucuugaaacacggaccaag

SEQ ID NO: 27 - RNA, 7 nt, Artificial Sequence
  Eukarya conserved nucleotide elements
acccgaa

SEQ ID NO: 28 - RNA, 8 nt, Artificial Sequence
  Eukarya conserved nucleotide elements
aacuaugc

SEQ ID NO: 29 - RNA, 9 nt, Artificial Sequence
  Eukarya conserved nucleotide elements
gaaacucug

SEQ ID NO: 30 - RNA, 15 nt, Artificial Sequence
  Eukarya conserved nucleotide elements
cugacgugcaaaucg

SEQ ID NO: 31 - RNA, 39 nt, Artificial Sequence
  Eukarya conserved nucleotide elements
gggcgaaagacuaaucgaaccaucuaguagcugguuccc

SEQ ID NO: 32 - RNA, 19 nt, Artificial Sequence
  Eukarya conserved nucleotide elements
aaguuucccucaggauagc

SEQ ID NO: 33 - RNA, 8 nt, Artificial Sequence
  Eukarya conserved nucleotide elements
gguaaagc

SEQ ID NO: 34 - RNA, 9 nt, Artificial Sequence
  Eukarya conserved nucleotide elements
aaugauuag

SEQ ID NO: 35 - RNA, 18 nt, Artificial Sequence
  Eukarya conserved nucleotide elements
ccuauucucaaacuuuaa

SEQ ID NO: 36 - RNA, 8 nt, Artificial Sequence
  Eukarya conserved nucleotide elements
gugggcca

SEQ ID NO: 37 - RNA, 9 nt, Artificial Sequence
  Eukarya conserved nucleotide elements
ugguaagca

SEQ ID NO: 38 - RNA, 7 nt, Artificial Sequence
  Eukarya conserved nucleotide elements
acuggcg

SEQ ID NO: 39 - RNA, 6 nt, Artificial Sequence
  Eukarya conserved nucleotide elements
ugaacc

SEQ ID NO: 40 - RNA, 7 nt, Artificial Sequence
  Eukarya conserved nucleotide elements
gacagca

SEQ ID NO: 41 - RNA, 8 nt, Artificial Sequence
  Eukarya conserved nucleotide elements
gacggugg

SEQ ID NO: 42 - RNA, 11 nt, Artificial Sequence
  Eukarya conserved nucleotide elements
cauggaagucg

SEQ ID NO: 43 - RNA, 37 nt, Artificial Sequence
  Eukarya conserved nucleotide elements
auccgcuaaggaguguguaacaacucaccugccgaau

SEQ ID NO: 44 - RNA, 24 nt, Artificial Sequence
  Eukarya conserved nucleotide elements
cuagcccugaaaauggauggcgcu

SEQ ID NO: 45 - RNA, 12 nt, Artificial Sequence
  Eukarya conserved nucleotide elements
gcagaucuuggu

SEQ ID NO: 46 - RNA, 18 nt, Artificial Sequence
  Eukarya conserved nucleotide elements
gguaguagcaaauauuca

SEQ ID NO: 47 - RNA, 8 nt, Artificial Sequence
  Eukarya conserved nucleotide elements
gguuccau

SEQ ID NO: 48 - RNA, 7 nt, Artificial Sequence
  Eukarya conserved nucleotide elements
uccuaag

SEQ ID NO: 49 - RNA, 8 nt, Artificial Sequence
  Eukarya conserved nucleotide elements
ucuuuucu

SEQ ID NO: 50 - RNA, 9 nt, Artificial Sequence
  Eukarya conserved nucleotide elements
ccuugaaaa

SEQ ID NO: 51 - RNA, 7 nt, Artificial Sequence
  Eukarya conserved nucleotide elements
ucguacu

SEQ ID NO: 52 - RNA, 22 nt, Artificial Sequence
  Eukarya conserved nucleotide elements
aaccgcaucaggucuccaaggu

SEQ ID NO: 53 - RNA, 9 nt, Artificial Sequence
  Eukarya conserved nucleotide elements
cagccucug

SEQ ID NO: 54 - RNA, 14 nt, Artificial Sequence
  Eukarya conserved nucleotide elements
agggaagucggcaa

SEQ ID NO: 55 - RNA, 14 nt, Artificial Sequence
  Eukarya conserved nucleotide elements
gauccguaacuucg

SEQ ID NO: 56 - RNA, 12 nt, Artificial Sequence
  Eukarya conserved nucleotide elements
aggauuggcucu

SEQ ID NO: 57 - RNA, 22 nt, Artificial Sequence
  Eukarya conserved nucleotide elements
auccgacuguuuaauuaaaaca

SEQ ID NO: 58 - RNA, 30 nt, Artificial Sequence
  Eukarya conserved nucleotide elements
gugauuucugcccagugcucugaaugucaa

SEQ ID NO: 59 - RNA, 7 nt, Artificial Sequence
  Eukarya conserved nucleotide elements
aauucaa

SEQ ID NO: 60 - RNA, 69 nt, Artificial Sequence
  Eukarya conserved nucleotide elements
caagcgcggguaaacggcgggaguaacuaugacucucuuaagguagccaaaugccucgucaucuaauua

SEQ ID NO: 61 - RNA, 41 nt, Artificial Sequence
  Eukarya conserved nucleotide elements
ugacgcgcaugaauggauuaacgagauucccacugucccua

SEQ ID NO: 62 - RNA, 35 nt, Artificial Sequence
  Eukarya conserved nucleotide elements
ucuacuaucuagcgaaaccacagccaagggaacgg

SEQ ID NO: 63 - RNA, 37 nt, Artificial Sequence
  Eukarya conserved nucleotide elements
agcggggaaagaagacccuguugagcuugacucuagu

SEQ ID NO: 64 - RNA, 12 nt, Artificial Sequence
  Eukarya conserved nucleotide elements
aaauaccacuac

SEQ ID NO: 65 - RNA, 10 nt, Artificial Sequence
  Eukarya conserved nucleotide elements
uuuacuuauu

SEQ ID NO: 66 - RNA, 7 nt, Artificial Sequence
  Eukarya conserved nucleotide elements
gaguuug

SEQ ID NO: 67 - RNA, 7 nt, Artificial Sequence
  Eukarya conserved nucleotide elements
cuggggc

SEQ ID NO: 68 - RNA, 8 nt, Artificial Sequence
  Eukarya conserved nucleotide elements
acaucugu

SEQ ID NO: 69 - RNA, 10 nt, Artificial Sequence
  Eukarya conserved nucleotide elements
guguccuaag

SEQ ID NO: 70 - RNA, 10 nt, Artificial Sequence
  Eukarya conserved nucleotide elements
acagaaaucu

SEQ ID NO: 71 - RNA, 6 nt, Artificial Sequence
  Eukarya conserved nucleotide elements
uugauu

SEQ ID NO: 72 - RNA, 9 nt, Artificial Sequence
  Eukarya conserved nucleotide elements
auuuucagu

SEQ ID NO: 73 - RNA, 18 nt, Artificial Sequence
  Eukarya conserved nucleotide elements
uggccuaucgauccuuua

SEQ ID NO: 74 - RNA, 35 nt, Artificial Sequence
  Eukarya conserved nucleotide elements
cagaaaaguuaccacagggauaacuggcuuguggc

SEQ ID NO: 75 - RNA, 59 nt, Artificial Sequence
  Eukarya conserved nucleotide elements
gccaagcguucauagcgacguugcuuuuugauccuucgaugucggcucuuccuaucauu

SEQ ID NO: 76 - RNA, 15 nt, Artificial Sequence
  Eukarya conserved nucleotide elements
ggauuguucacccac

SEQ ID NO: 77 - RNA, 56 nt, Artificial Sequence
  Eukarya conserved nucleotide elements
agggaacgugagcuggguuuagaccgucgugagacagguuaguuuuacccuacuga

SEQ ID NO: 78 - RNA, 15 nt, Artificial Sequence
  Eukarya conserved nucleotide elements
uaguacgagaggaac

SEQ ID NO: 79 - RNA, 8 nt, Artificial Sequence
  Eukarya conserved nucleotide elements
cgccucua

SEQ ID NO: 80 - RNA, 10 nt, Artificial Sequence
  Archaea conserved nucleotide elements
aaacaucuua

SEQ ID NO: 81 - RNA, 6 nt, Artificial Sequence
  Archaea conserved nucleotide elements
uaaaua

SEQ ID NO: 82 - RNA, 8 nt, Artificial Sequence
  Archaea conserved nucleotide elements
accgauag

SEQ ID NO: 83 - RNA, 8 nt, Artificial Sequence
  Archaea conserved nucleotide elements
cugaaaag

SEQ ID NO: 84 - RNA, 6 nt, Artificial Sequence
  Archaea conserved nucleotide elements
ugaaac

SEQ ID NO: 85 - RNA, 7 nt, Artificial Sequence
  Archaea conserved nucleotide elements
cgaucua

SEQ ID NO: 86 - RNA, 6 nt, Artificial Sequence
  Archaea conserved nucleotide elements
ccaauc

SEQ ID NO: 87 - RNA, 9 nt, Artificial Sequence
  Archaea conserved nucleotide elements
cugguuccc

SEQ ID NO: 88 - RNA, 12 nt, Artificial Sequence
  Archaea conserved nucleotide elements
ucaaacuccgaa

SEQ ID NO: 89 - RNA, 8 nt, Artificial Sequence
  Archaea conserved nucleotide elements
gguuaagg

SEQ ID NO: 90 - RNA, 7 nt, Artificial Sequence
  Archaea conserved nucleotide elements
cuaagug

SEQ ID NO: 91 - RNA, 6 nt, Artificial Sequence
  Archaea conserved nucleotide elements
agcagc

SEQ ID NO: 92 - RNA, 8 nt, Artificial Sequence
  Archaea conserved nucleotide elements
cguaacag

SEQ ID NO: 93 - RNA, 6 nt, Artificial Sequence
  Archaea conserved nucleotide elements
uggacc

SEQ ID NO: 94 - RNA, 6 nt, Artificial Sequence
  Archaea conserved nucleotide elements
auccug

SEQ ID NO: 95 - RNA, 9 nt, Artificial Sequence
  Archaea conserved nucleotide elements
gguccuaag

SEQ ID NO: 96 - RNA, 12 nt, Artificial Sequence
  Archaea conserved nucleotide elements
gguuaauauucc

SEQ ID NO: 97 - RNA, 6 nt, Artificial Sequence
  Archaea conserved nucleotide elements
cguaau

SEQ ID NO: 98 - RNA, 6 nt, Artificial Sequence
  Archaea conserved nucleotide elements
ugaaaa

SEQ ID NO: 99 - RNA, 7 nt, Artificial Sequence
  Archaea conserved nucleotide elements
ccguacc

SEQ ID NO: 100 - RNA, 6 nt, Artificial Sequence
  Archaea conserved nucleotide elements
agggaa

SEQ ID NO: 101 - RNA, 10 nt, Artificial Sequence
  Archaea conserved nucleotide elements
ucggcaaauu

SEQ ID NO: 102 - RNA, 6 nt, Artificial Sequence
  Archaea conserved nucleotide elements
uaacuu

SEQ ID NO: 103 - RNA, 6 nt, Artificial Sequence
  Archaea conserved nucleotide elements
gucgca

SEQ ID NO: 104 - RNA, 11 nt, Artificial Sequence
  Archaea conserved nucleotide elements
gacuguuuaau

SEQ ID NO: 105 - RNA, 6 nt, Artificial Sequence
  Archaea conserved nucleotide elements
aacaua

SEQ ID NO: 106 - RNA, 9 nt, Artificial Sequence
  Archaea conserved nucleotide elements
gguaacuau

SEQ ID NO: 107 - RNA, 16 nt, Artificial Sequence
  Archaea conserved nucleotide elements
acccucuuaagguagc

SEQ ID NO: 108 - RNA, 9 nt, Artificial Sequence
  Archaea conserved nucleotide elements
uaccuugcc

SEQ ID NO: 109 - RNA, 8 nt, Artificial Sequence
  Archaea conserved nucleotide elements
gcaugaau

SEQ ID NO: 110 - RNA, 9 nt, Artificial Sequence
  Archaea conserved nucleotide elements
cacuguccc

SEQ ID NO: 111 - RNA, 7 nt, Artificial Sequence
  Archaea conserved nucleotide elements
aagaccc

SEQ ID NO: 112 - RNA, 13 nt, Artificial Sequence
  Archaea conserved nucleotide elements
gagcuuuacugca

SEQ ID NO: 113 - RNA, 6 nt, Artificial Sequence
  Archaea conserved nucleotide elements
gcaguu

SEQ ID NO: 114 - RNA, 6 nt, Artificial Sequence
  Archaea conserved nucleotide elements
agaaaa

SEQ ID NO: 115 - RNA, 7 nt, Artificial Sequence
  Archaea conserved nucleotide elements
cuacccc

SEQ ID NO: 116 - RNA, 7 nt, Artificial Sequence
  Archaea conserved nucleotide elements
ggauaac

SEQ ID NO: 117 - RNA, 10 nt, Artificial Sequence
  Archaea conserved nucleotide elements
uugcuaccuc

SEQ ID NO: 118 - RNA, 7 nt, Artificial Sequence
  Archaea conserved nucleotide elements
gaugucg

SEQ ID NO: 119 - RNA, 9 nt, Artificial Sequence
  Archaea conserved nucleotide elements
ccauccugg

SEQ ID NO: 120 - RNA, 6 nt, Artificial Sequence
  Archaea conserved nucleotide elements
aagggu

SEQ ID NO: 121 - RNA, 11 nt, Artificial Sequence
  Archaea conserved nucleotide elements
ccuauuaaagg

SEQ ID NO: 122 - RNA, 31 nt, Artificial Sequence
  Archaea conserved nucleotide elements
ugagcuggguuuagaccgucgugagacaggu

SEQ ID NO: 123 - RNA, 15 nt, Artificial Sequence
  Archaea conserved nucleotide elements
uaguacgagaggaac

SEQ ID NO: 124 - RNA, 6 nt, Artificial Sequence
  Archaea conserved nucleotide elements
guuguc

SEQ ID NO: 125 - RNA, 6 nt, Artificial Sequence
  Archaea conserved nucleotide elements
gcugaa

SEQ ID NO: 126 - RNA, 10 nt, Artificial Sequence
  Archaea conserved nucleotide elements
gcaucuaagc

SEQ ID NO: 127 - RNA, 10 nt, Artificial Sequence
  Bacteria conserved nucleotide elements
ugaaacaucu

SEQ ID NO: 128 - RNA, 6 nt, Artificial Sequence
  Bacteria conserved nucleotide elements
cuaaau

SEQ ID NO: 129 - RNA, 8 nt, Artificial Sequence
  Bacteria conserved nucleotide elements
accgauag

SEQ ID NO: 130 - RNA, 8 nt, Artificial Sequence
  Bacteria conserved nucleotide elements
aguaccgu

SEQ ID NO: 131 - RNA, 7 nt, Artificial Sequence
  Bacteria conserved nucleotide elements
ccuuuug

SEQ ID NO: 132 - RNA, 7 nt, Artificial Sequence
  Bacteria conserved nucleotide elements
acccgaa

SEQ ID NO: 133 - RNA, 7 nt, Artificial Sequence
  Bacteria conserved nucleotide elements
ugaucua

SEQ ID NO: 134 - RNA, 6 nt, Artificial Sequence
  Bacteria conserved nucleotide elements
ccgaac

SEQ ID NO: 135 - RNA, 14 nt, Artificial Sequence
  Bacteria conserved nucleotide elements
auagcugguucucc

SEQ ID NO: 136 - RNA, 6 nt, Artificial Sequence
  Bacteria conserved nucleotide elements
agcacu

SEQ ID NO: 137 - RNA, 7 nt, Artificial Sequence
  Bacteria conserved nucleotide elements
caaacuc

SEQ ID NO: 138 - RNA, 10 nt, Artificial Sequence
  Bacteria conserved nucleotide elements
gaagcagcca

SEQ ID NO: 139 - RNA, 16 nt, Artificial Sequence
  Bacteria conserved nucleotide elements
gcguaauagcucacug

SEQ ID NO: 140 - RNA, 6 nt, Artificial Sequence
  Bacteria conserved nucleotide elements
ugagua

SEQ ID NO: 141 - RNA, 6 nt, Artificial Sequence
  Bacteria conserved nucleotide elements
ccuaag

SEQ ID NO: 142 - RNA, 6 nt, Artificial Sequence
  Bacteria conserved nucleotide elements
cguacc

SEQ ID NO: 143 - RNA, 8 nt, Artificial Sequence
  Bacteria conserved nucleotide elements
accgacac

SEQ ID NO: 144 - RNA, 11 nt, Artificial Sequence
  Bacteria conserved nucleotide elements
aggaacucggc

SEQ ID NO: 145 - RNA, 12 nt, Artificial Sequence
  Bacteria conserved nucleotide elements
ccguaacuucgg

SEQ ID NO: 146 - RNA, 9 nt, Artificial Sequence
  Bacteria conserved nucleotide elements
gacuguuua

SEQ ID NO: 147 - RNA, 10 nt, Artificial Sequence
  Bacteria conserved nucleotide elements
aaaaacacag

SEQ ID NO: 148 - RNA, 13 nt, Artificial Sequence
  Bacteria conserved nucleotide elements
acgccugcccggu

SEQ ID NO: 149 - RNA, 6 nt, Artificial Sequence
  Bacteria conserved nucleotide elements
aagccc

SEQ ID NO: 150 - RNA, 6 nt, Artificial Sequence
  Bacteria conserved nucleotide elements
aacggc

SEQ ID NO: 151 - RNA, 42 nt, Artificial Sequence
  Bacteria conserved nucleotide elements
ccguaacuauaacgguccuaagguagcgaaauuccuugucgg

SEQ ID NO: 152 - RNA, 21 nt, Artificial Sequence
  Bacteria conserved nucleotide elements
guaaguuccgaccugcacgaa

SEQ ID NO: 153 - RNA, 8 nt, Artificial Sequence
  Bacteria conserved nucleotide elements
acugucuc

SEQ ID NO: 154 - RNA, 11 nt, Artificial Sequence
  Bacteria conserved nucleotide elements
aaagaccccgu

SEQ ID NO: 155 - RNA, 9 nt, Artificial Sequence
  Bacteria conserved nucleotide elements
accuuuacu

SEQ ID NO: 156 - RNA, 6 nt, Artificial Sequence
  Bacteria conserved nucleotide elements
ucuaac

SEQ ID NO: 157 - RNA, 7 nt, Artificial Sequence
  Bacteria conserved nucleotide elements
caguuug

SEQ ID NO: 158 - RNA, 6 nt, Artificial Sequence
  Bacteria conserved nucleotide elements
uggggc

SEQ ID NO: 159 - RNA, 9 nt, Artificial Sequence
  Bacteria conserved nucleotide elements
gccucccaa

SEQ ID NO: 160 - RNA, 8 nt, Artificial Sequence
  Bacteria conserved nucleotide elements
guaacgga

SEQ ID NO: 161 - RNA, 7 nt, Artificial Sequence
  Bacteria conserved nucleotide elements
uugacug

SEQ ID NO: 162 - RNA, 10 nt, Artificial Sequence
  Bacteria conserved nucleotide elements
uagugauccg

SEQ ID NO: 163 - RNA, 10 nt, Artificial Sequence
  Bacteria conserved nucleotide elements
ucgcucaacg

SEQ ID NO: 164 - RNA, 8 nt, Artificial Sequence
  Bacteria conserved nucleotide elements
gauaaaag

SEQ ID NO: 165 - RNA, 16 nt, Artificial Sequence
  Bacteria conserved nucleotide elements
gggauaacaggcugau

SEQ ID NO: 166 - RNA, 10 nt, Artificial Sequence
  Bacteria conserved nucleotide elements
cacaucgacg

SEQ ID NO: 167 - RNA, 26 nt, Artificial Sequence
  Bacteria conserved nucleotide elements
guuuggcaccucgaugucggcucauc

SEQ ID NO: 168 - RNA, 9 nt, Artificial Sequence
  Bacteria conserved nucleotide elements
cauccuggg

SEQ ID NO: 169 - RNA, 11 nt, Artificial Sequence
  Bacteria conserved nucleotide elements
gucccaagggu

SEQ ID NO: 170 - RNA, 11 nt, Artificial Sequence
  Bacteria conserved nucleotide elements
ggcuguucgcc

SEQ ID NO: 171 - RNA, 6 nt, Artificial Sequence
  Bacteria conserved nucleotide elements
uuaaag

SEQ ID NO: 172 - RNA, 12 nt, Artificial Sequence
  Bacteria conserved nucleotide elements
gagcuggguuca

SEQ ID NO: 173 - RNA, 30 nt, Artificial Sequence
  Bacteria conserved nucleotide elements
gaacgucgugagacaguucggucccuaucu

SEQ ID NO: 174 - RNA, 16 nt, Artificial Sequence
  Bacteria conserved nucleotide elements
cuaguacgagaggacc

SEQ ID NO: 175 - RNA, 8 nt, Artificial Sequence
  Bacteria conserved nucleotide elements
gcaucuaa